(19) United States
(12) Patent Application Publication
(10) Pub. No.: US 2025/0130552 A1
(43) Pub. Date: Apr. 24, 2025

(54) SYSTEMS AND METHODS FOR FUEL EXCHANGE AUTHORIZATION AND OPTIMIZATION

(71) Applicant: Mudflap, Inc., Palo Alto, CA (US)

(72) Inventors: Sharon YAPP, Campbell, CA (US); Vineet THANEDAR, Oakland, CA (US)

(21) Appl. No.: 18/491,539

(22) Filed: Oct. 20, 2023

(51) Int. Cl. G05B 19/4155

(52) U.S. Cl. CPC G05B 19/4155; G05B 2219/45076

(57) ABSTRACT

Fuel exchange authorization and can be performed and optimized by receiving a user input indicative of a fuel code. The user input is temporarily stored according to a third-party storage instruction. A fuel authorization data object is provided to the remote computing environment using a fuel exchange processing service and an application programming interface (API). A validation of the fuel code is generated by the remote computing environment based on a comparison of the user input to the fuel code. The validation is received from the remote computing environment via the fuel exchange processing service and the API. In response to receiving the validation of the fuel code, an exchange payload is generated and provided to the remote computing environment via the fuel exchange processing service and the API, the exchange payload being indicative of a fuel exchange amount, the identifier of the fuel entity, and the fuel code.

### BACKGROUND

Obtaining fuel (e.g., vehicle fuel, such as diesel fuel for long-haul truckers) from a fueling station has historically required the fuel recipient to be present at fueling station to initiate a desired exchange of fuel. Computing systems located at the fueling station historically have not been remotely accessible to truckers, drivers, and/or other fuel recipients, and therefore those fuel recipients have been unable to provide information necessary for a fuel exchange unless and until the fuel recipient has physically reached the fueling station. Even at fueling stations where information, such as identifiers, keys, and other sensitive information necessary to conduct a fuel exchange can be provided directly to a fuel pump, the provision of that information can decrease the efficiency of a fuel stop for truckers and other fuel recipients. Therefore, a need exists for improved special purpose computing devices and/or software or firmware for increasing the efficiency of fuel stops for drivers by providing additional options for drivers and other fuel recipients to initiate a least a portion of a fuel exchange remotely. Through applied effort and ingenuity, various technical problems associated with historical fuel exchange processing have been solved through embodiments as discussed herein.

### BRIEF SUMMARY

Various embodiments are directed to a system, method, and computer program product for initiating and authorizing fuel-related exchanges. Various embodiments receive a user input indicative of a fuel code, receive a validation of the fuel code from a remote computing environment and, in response to the validation, generate a fuel exchange payload and provide the fuel exchange payload to the remote computing environment. In one or more embodiments, by use of the fuel code, the present systems and methods overcome security challenges of previous approaches that expose sensitive information of a user's instrument of exchange to a fuel exchange system. Additionally, the system, method, and computer program product of the present disclosure may perform fuel exchanges in which modifications to fuel exchange values or other metrics may be associated with and redeemed respective to an identity of a user entity without exposing identifying information of the user entity to the associated fuel exchange system.

Various embodiments are directed to a system for authorizing and optimizing fuel-related exchanges. In certain embodiments, the system comprises: at least one memory, and one or more processors in communication with the at least one memory and collectively configured to: (i) receive, at a fuel exchange system, a user input indicative of a fuel code via a fuel exchange software interface, where the fuel code is generated by a remote computing environment which stores the fuel code in association with an identifier of a fuel entity associated with the fuel exchange system and which provides the fuel code to a user computing entity, (ii) temporarily store, in the at least one memory, the user input according to a third-party storage instruction executable by the fuel exchange system, (iii) provide, using a fuel exchange processing service and an application programming interface (API), a fuel exchange authorization data object indicative of the user input to the remote computing environment. (iv) receive, at the fuel exchange system, a validation of the fuel code, where: the remote computing environment generates the validation of the fuel code based on a comparison of the user input to the fuel code, and the validation of the fuel code is received from the remote computing environment via the fuel exchange processing service and the API, (v) in response to receiving the validation of the fuel code, generate a fuel exchange payload indicative of a fuel exchange amount, the identifier of the fuel entity associated with the fuel exchange system, and the fuel code, and (vi) provide, using the fuel exchange processing service and the API, the fuel exchange payload to the remote computing environment.

In some embodiments, the one or more processors are configured to, in response to receiving the validation of the fuel code, transition a fueling system from an inactive state to an active state, where the fuel exchange amount is based on a fuel event associated with the fueling system in the active state. In various embodiments, the fuel exchange authorization data object comprises metadata indicative of a receipt timestamp of the user input. In some embodiments, the remote computing environment generates the validation of the fuel code further based on determining the receipt timestamp is within a predetermined activation interval. In various embodiments, the fuel exchange authorization data object comprises an entity identifier. In some embodiments, the remote computing environment generates the validation of the fuel code further based on a comparison between the entity identifier and the identifier of the fuel entity associated with the fuel code at the remote computing environment. In some embodiments, the remote computing environment generates the validation of the fuel code further based on determining the user computing entity is within a predetermined proximity to a fueling location associated with the fuel entity.

In various embodiments, the one or more processors are further configured to install the third-party storage instruction at the fuel exchange system prior to receiving the user input. In various embodiments, the one or more processors are further configured to receive, at the fuel exchange system, a fuel exchange ratio from the remote computing environment via the fuel exchange processing service and the API. In some embodiments, the one or more processors are further configured to generate the fuel exchange amount at least partially based upon the fuel exchange ratio. In some embodiments, the remote computing environment stores the fuel exchange ratio in association with the fuel code and the identifier of the fuel entity.

In various embodiments, the remote computing environment determines a user account based on the fuel code. In some embodiments, the remote computing environment updates the user account based on the fuel exchange amount and the identifier of the fuel entity associated with the fuel exchange system. In some embodiments, the fuel exchange interface comprises a computing device in communication with the fuel exchange system. In some embodiments, the third-party storage instruction, when installed at the fuel exchange system, causes the fuel exchange system to: determine the user input comprises a predetermined format defined by the third-party storage instruction, and, in response to determining the user input comprises the predetermined format, provide, using the fuel exchange processing service and the API, the fuel exchange authorization data object indicative of the user input to the remote computing environment.

Certain embodiments are directed to a method fuel exchange authorization and optimization. In various embodiments, the method comprises: (i) receiving, at a fuel exchange system, a user input indicative of a fuel code via a fuel exchange software interface, where the fuel code is generated by a remote computing environment which stores the fuel code in association with an identifier of a fuel entity associated with the fuel exchange system and which provides the fuel code to a user computing entity, (ii) temporarily storing, in a memory of the fuel exchange system, the user input according to a third-party storage instruction executable by the fuel exchange system, (iii) providing, using a fuel exchange processing service and an application programming interface (API), a fuel exchange authorization data object indicative of the user input to the remote computing environment, (iv) receiving, at the fuel exchange system, a validation of the fuel code, where: the remote computing environment generates the validation of the fuel code based on a comparison of the user input to the fuel code, and the validation of the fuel code is received from the remote computing environment via the fuel exchange processing service and the API, (v) in response to receiving the validation of the fuel code, generating a fuel exchange payload indicative of a fuel exchange amount, the identifier of the fuel entity associated with the fuel exchange system, and the fuel code, and (vi) providing, using the fuel exchange processing service and the API, the fuel exchange payload to the remote computing environment

In various embodiments, the method further comprises, in response to receiving the validation of the fuel code, transitioning a fueling system from an inactive state to an active state, where the fuel exchange amount is based on a fuel event associated with the fueling system in the active state. In some embodiments, the fuel exchange authorization data object comprises metadata indicative of a receipt timestamp of the user input. In some embodiments, the remote computing environment generates the validation of the fuel code further based on determining the receipt timestamp is within a predetermined activation interval. In some embodiments, the fuel exchange authorization data object comprises an entity identifier. In some embodiments, the remote computing environment generates the validation of the fuel code further based on a comparison between the entity identifier and the identifier of the fuel entity associated with the fuel code at the remote computing environment. In some embodiments, the remote computing environment generates the validation of the fuel code further based on determining the user computing entity is within a predetermined proximity to a fueling location associated with the fuel entity.

In various embodiments, the method further comprises receiving, at the fuel exchange system, a fuel exchange ratio from the remote computing environment via the fuel exchange processing service and the API, and generating the fuel exchange amount at least partially based upon the fuel exchange ratio. In some embodiments, the remote computing environment stores the fuel exchange ratio in association with the fuel code and the identifier of the fuel entity. In some embodiments, the method further comprises installing the third-party storage instruction at the fuel exchange system prior to receiving the user input. In some embodiments, the third-party storage instruction, when installed at the fuel exchange system, causes the fuel exchange system to determine the user input comprises a predetermined format defined by the third-party storage instruction, and in response to determining the user input comprises the predetermined format, provide, using the fuel exchange processing service and the API, the fuel exchange authorization data object indicative of the user input to the remote computing environment.

In various embodiments, the method further comprises determining, using the remote computing environment, a user account based on the fuel code, and updating, using the remote computing environment, the user account based on the fuel exchange amount and the identifier of the fuel entity associated with the fuel exchange system. In some embodiments, the fuel exchange software interface comprises a computing device in communication with the fuel exchange system.

Certain embodiments are directed to a computer program product comprising a non-transitory computer readable medium having computer program instructions stored therein, the computer program instructions, when executed by a processor, cause the processor to: (i) receive, at a fuel exchange system, a user input indicative of a fuel code via a fuel exchange software interface, where the fuel code is generated by a remote computing environment which stores the fuel code in association with an identifier of a fuel entity associated with the fuel exchange system and which provides the fuel code to a user computing entity, (ii) temporarily store, in the at least one memory, the user input according to a third-party storage instruction executable by the fuel exchange system, (iii) provide, using a fuel exchange processing service and an application programming interface (API), a fuel exchange authorization data object indicative of the user input to the remote computing environment. (iv) receive, at the fuel exchange system, a validation of the fuel code, where: the remote computing environment generates the validation of the fuel code based on a comparison of the user input to the fuel code, and the validation of the fuel code is received from the remote computing environment via the fuel exchange processing service and the API, (v) in response to receiving the validation of the fuel code, generate a fuel exchange payload indicative of a fuel exchange amount, the identifier of the fuel entity associated with the fuel exchange system, and the fuel code, and (vi) provide, using the fuel exchange processing service and the API, the fuel exchange payload to the remote computing environment.

In some embodiments, the computer program instructions, when executed by the processor, further cause the processor to, in response to receiving the validation of the fuel code, transition a fueling system from an inactive state to an active state, where the fuel exchange amount is based on a fuel event associated with the fueling system in the active state. In various embodiments, the fuel exchange authorization data object comprises metadata indicative of a receipt timestamp of the user input. In some embodiments, the remote computing environment generates the validation of the fuel code further based on determining the receipt timestamp is within a predetermined activation interval. In various embodiments, the fuel exchange authorization data object comprises an entity identifier. In some embodiments, the remote computing environment generates the validation of the fuel code further based on a comparison between the entity identifier and the identifier of the fuel entity associated with the fuel code at the remote computing environment. In some embodiments, the remote computing environment generates the validation of the fuel code further based on determining the user computing entity is within a predetermined proximity to a fueling location associated with the fuel entity.

In various embodiments, the computer program instructions, when executed by the processor, further cause the processor to install the third-party storage instruction at the fuel exchange system prior to receiving the user input. In various embodiments, the computer program instructions, when executed by the processor, further cause the processor to receive, at the fuel exchange system, a fuel exchange ratio from the remote computing environment via the fuel exchange processing service and the API. In some embodiments, the computer program instructions, when executed by the processor, further cause the processor to generate the fuel exchange amount at least partially based upon the fuel exchange ratio. In some embodiments, the remote computing environment stores the fuel exchange ratio in association with the fuel code and the identifier of the fuel entity.

In various embodiments, the remote computing environment determines a user account based on the fuel code. In some embodiments, the remote computing environment updates the user account based on the fuel exchange amount and the identifier of the fuel entity associated with the fuel exchange system. In some embodiments, the fuel exchange interface comprises a computing device in communication with the fuel exchange system. In some embodiments, the third-party storage instruction, when installed at the fuel exchange system, causes the fuel exchange system to: determine the user input comprises a predetermined format defined by the third-party storage instruction, and, in response to determining the user input comprises the predetermined format, provide, using the fuel exchange processing service and the API, the fuel exchange authorization data object indicative of the user input to the remote computing environment.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates a network environment encompassing a plurality of computing entities and systems for initiation and authorization of fuel exchanges;

FIG. 2 schematically illustrates features of a remote server according to certain embodiments;

FIG. 3 schematically illustrates features of a fuel exchange system according to certain embodiments;

FIG. 4 provides an example data flow among a plurality of computing entities and systems for authorizing a fuel exchange according to certain embodiments;

FIG. 5 provides an example flowchart of an example process for authorizing a fuel exchange according to certain embodiments;

FIG. 6 provides an example data architecture according to certain embodiments;

FIG. 7 provides an example flowchart of an example process for validating a fuel code according to certain embodiments;

FIG. 8 provides an example fuel exchange software interface for receiving a user input indicative of a fuel code according to certain embodiments; and

FIG. 9 provides an example graphical user interface for providing a fuel code to a fuel exchange system according to certain embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments are directed to systems and methods for fuel exchange authorization and optimization. In some embodiments, the system includes a fuel exchange system configured to transmit and receive fuel exchange data to and from a remote computing environment via a fuel exchange processing service and one or more application programming interfaces (APIs). In some embodiments, the remote computing environment is configured to communicate with one or more user computing entities, such as a computing device (e.g., a smartphone, laptop, or other portable computing device) of a user. In various embodiments, the remote computing environment generates and provides to the user computing entity a fuel code. For example, in response to receiving a request from a user computing entity to obtain a fuel code, the remote computing environment may generate a fuel code and provide the fuel code to the user computing entity. In some embodiments, the fuel code is a single-use redeemable, revokable token by which a fuel exchange may be initiated and processed on behalf of the user computing entity and a fuel exchange system that receives an input indicative of the fuel code. In some embodiments, the remote computing environment associates the fuel code with data for a user computing entity's instrument of exchange. In some embodiments, the remote computing environment initiates exchanges of value for fuel exchanges in response to receiving and validating a user input indicative of the fuel code. In various embodiments, the fuel code is provided to a fuel exchange system instead of the fuel exchange system being provided sensitive information operative for initiating exchanges of value using a user's entity's instrument of exchange. The fuel code may be used by the fuel exchange system to obtain authorization for a fuel exchange by providing the fuel code to a fuel exchange processing service that relays the fuel code to the remote computing environment. In some embodiments, such techniques may overcome deficiencies in previous fuel exchange processing solutions that undesirably expose sensitive information to a fuel exchange system and/or operator thereof.

As used herein, “fuel exchange” refers to an exchange of value between a fuel entity and a user entity for a fuel event. For example, a fuel exchange may include a transaction for purchase of a particular amount of fuel (e.g., diesel fuel) from a fuel entity to be provided to a fuel recipient, such as a vehicle driver, a long-haul trucker, and/or other fuel recipient, where the particular amount of fuel is associated with a fuel event comprising depositing the diesel fuel into a vehicle of a user entity. A fuel exchange may be associated with an identifier, referred to as a fuel exchange identifier, and metadata. Non-limiting examples of the metadata include timestamps, geolocation data, fuel type, fuel volume, fuel exchange ratio, identifiers for an associated fuel entity, user entity, or user computing entity, and/or the like. A value associated with a fuel exchange is referred to herein as a fuel exchange amount.

As used herein, “fuel event” refers to an instance in which an amount of fuel from a fuel entity is deposited into a vehicle or other container, of a user entity, or otherwise where an amount of fuel is sequestered from or reserved by the fuel entity on behalf of the user entity. In one example, a fuel event includes a vehicle of a user entity receiving an amount of diesel fuel from a fueling station that is associated with a fuel entity. In another example, a fuel event includes a user entity, or agent of a fuel entity, depositing an amount of fuel into a fuel container. In another example, a fuel event includes allocating an amount fuel to a user entity so as to reserve the amount fuel for use or collection by the user entity. A fuel event and/or fuel exchange may occur at a physical establishment associated with a fuel entity, such as a fuel depot, filling station, gas station, and/or the like. Additionally, or alternatively, a fuel event may occur at a first location and a fuel exchange may be initiated at a second location, which may be a physical location or a virtual location. A fuel event may be associated with one or more identifiers, referred to as fuel event identifiers, and metadata. Non-limiting examples of the metadata include timestamps, geolocation data associated with a location of the fuel event, fuel type, fuel exchange amount, fuel exchange ratio, identifiers for an associated fuel entity, user entity, or user computing entity, and/or the like.

It should be understood that fuel types are not limited to diesel fuels. As used herein, fuels involved in a fuel event may encompass the non-limiting examples of diesel, biodiesel, unleaded gasoline, leaded gasoline, off-road rated diesel, off-road rated gasoline, ethanol, kerosene, propane, liquid hydrogen, fuel oil, and/or the like. For certain fuel stations capable of metering electricity as a fuel to be provided to a vehicle (or other electricity storage device), the embodiments discussed herein can be utilized for fuel exchange transactions for providing electrical power for storage in a vehicle or other storage device.

As used herein, “fuel entity” refers to a provider of fuel. For example, a fuel entity may be an owner and/or operator of a gas station. In another example, a fuel entity may be a wholesale supplier of fuel. In still another example, a fuel entity may be a third-party fuel broker. A fuel entity may be associated with one or more fueling locations at which fuel exchanges are initiated and/or fuel is provided to a user entity. A fuel entity may be associated with one or more identifiers, referred to as entity identifiers and metadata. Non-limiting examples of the metadata include a location of the fuel entity, or fueling location associated therewith, data indicative of one or more instruments of exchange of a fuel entity (e.g., financial account numbers, routing numbers, etc.), legal name of a fuel entity, retail licensure data associated with the fuel entity, and/or the like.

As used herein, “user entity” (or “fuel recipient”) refers to any entity that enters into an exchange of value with a fuel entity to obtain fuel. In one example, a user entity may be an individual that obtains fuel for their vehicle from a filling station (e.g., the filling station being associated with a particular fuel entity). In another example, a user entity may be a business or other organization that obtains or reserves fuel from a fuel depot or fuel supply network associated with a fuel entity. In some embodiments, a user entity is associated with a user computing entity. In various embodiments, the user computing entity includes any computing device configured to communicate with the remote computing environment. For example, the user computing entity may be a computing device configured to transmit fuel code request to and receive fuel codes from the remote computing environment.

As used herein, “fuel code” refers to a redeemable, revokable token by which a fuel exchange may be initiated and processed on behalf of a user entity and a fuel exchange system of a fuel entity that receives an input indicative of the fuel code. In various embodiments, the fuel code is a numeric or alphanumeric string generated by one or more embodiments of a remote computing environment described herein. In some embodiments, the fuel code includes a numeric or alphanumeric string of a predetermined format, such as a particular length and/or character combination(s), by which a fuel exchange system may identify the string as a fuel code based at least in part on a third-party storage instruction installed at the fuel exchange system.

In some embodiments, the system, method, and computer program product of the present disclosure utilize a fuel code to obtain authorization for a fuel exchange between a user entity and a fuel entity without exposing sensitive information of the user entity to the fuel entity. For example, the remote computing environment may generate the fuel code in response to receiving a request from a user computing entity, where the request indicates the fuel code will be utilized for a fuel exchange at a particular fueling location and/or in association with a particular fuel entity. In some embodiments, a fuel code is associated with a stored record for an instrument of exchange associated with a user entity. For example, a fuel code may be associated with credit card processing data for a credit card account of a user entity, including card number, expiration date, card verification value, virtual card information, and/or the like. The remote computing environment may store the record for the instrument of exchange and use the stored record to initiate exchanges of value in response to receiving and validating a fuel exchange authorization data object indicative of the corresponding fuel code.

### Computer Program Products, Methods, and Computing Entities

Embodiments of the present techniques for fuel exchange authorization and optimization may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution). The terms software, computer program product, and similar words may be used herein interchangeably.

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile memory).

In one embodiment, a non-volatile computer-readable storage medium may include a floppy disk, flexible disk, hard disk, solid-state storage (SSS) (e.g., a solid state drive (SSD), solid state card (SSC), or solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-recordable (CD-R), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present techniques for fuel exchange authorization and optimization may also be implemented as methods, apparatus, systems, computing devices, computing entities, and/or the like. As such, embodiments of the present techniques for fuel exchange authorization and optimization may take the form of an apparatus, system, computing device, computing entity, and/or the like executing instructions stored on a computer-readable storage medium to perform certain steps or operations. Thus, embodiments of the present techniques for fuel exchange authorization and optimization may also take the form of an entirely hardware embodiment, an entirely computer program product embodiment, and/or an embodiment that comprises combination of computer program products and hardware performing certain steps or operations.

Embodiments of the present techniques for fuel exchange authorization and optimization are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

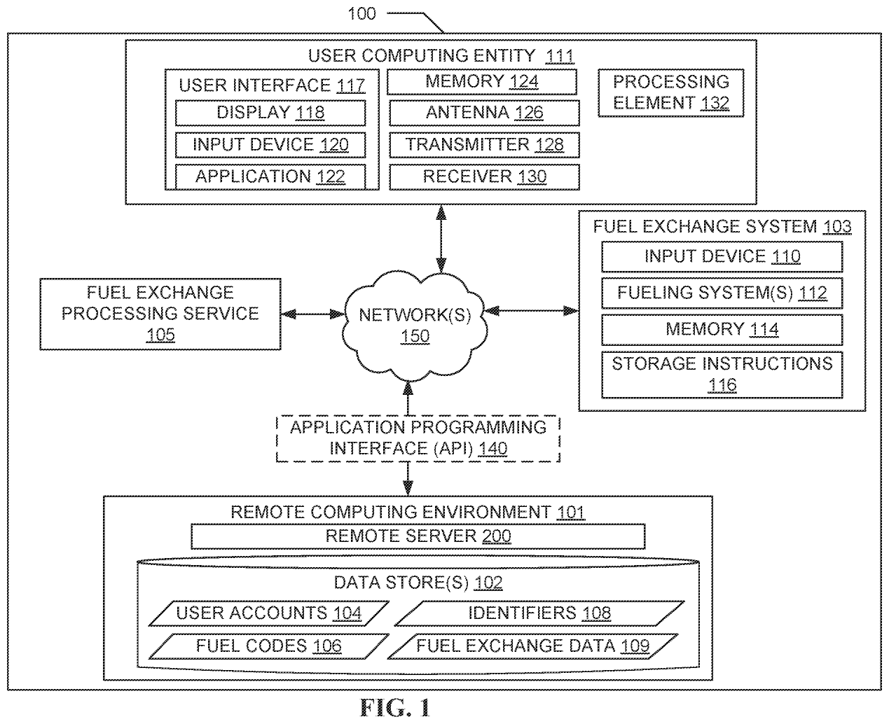

FIG. 1 provides an illustration of an exemplary computer-based network environment for fuel exchange authorization and optimization. As shown in FIG. 1, embodiments may include a network environment 100 including a remote computing environment 101, one or more fuel exchange systems 103, one or more fuel exchange processing services 105, and one or more user computing entities 111. The network environment 100 may include one or more networks 150 enabling communication among elements of the network environment 100. For example, a first network 150 may enable communication between a fuel exchange system and a fuel exchange processing service 105, a second network 150 may enable communication between the remote computing environment 101 and a user computing entity 111, and a third network 150 may enable communication between the remote computing environment 101 and the fuel exchange processing service 105. In some embodiments, the network environment 100 includes one or more application programming interfaces (APIs) 140 that enable communication, via one or more networks 150, between the remote computing environment 101 and a fuel exchange processing service 105, between the remote computing environment 101 and a user computing entity 111, and/or between the remote computing environment 101 and a fuel exchange system 103. In some embodiments, an API 140 and a fuel exchange processing service 105 enable communication between the remote computing environment 101 and a fuel exchange system 103. For example, using the API 140 and a fuel exchange processing service 105, a fuel exchange system 103 may provide a fuel exchange authorization data object indicative of a fuel code to the remote computing environment 101. In another example, using the API 140 and a fuel exchange processing service 105, a fuel exchange system 103 may receive a validation of a fuel exchange authorization data object generated by the remote computing environment 101. In another example, using the API 140 and a fuel exchange processing service 105, a fuel exchange system 103 may provide a fuel exchange payload to the remote computing environment 101. In still another example, using the API 140 and a fuel exchange processing service 105, a fuel exchange system 103 receives a fuel exchange ratio from the remote computing environment 101.

In various embodiments, the remote computing environment 101 includes one or more remote servers 200 configured to perform various functions and operations to authorize and optimize fuel exchanges. The elements of the remote computing environment 101 may be provided via a plurality of computing devices that may be arranged, for example, in one or more server banks or computer banks or other arrangements. Such computing devices can be located in a single installation or may be distributed among many different geographical locations. For example, the remote computing environment 101 can include a plurality of computing devices that together may include a hosted computing resource, a grid computing resource, and/or any other distributed computing arrangement. In some cases, the remote computing environment 101 can correspond to an elastic computing resource where the allotted capacity of processing, network, storage, or other computing-related resources may vary over time.

In various embodiments, the remote computing environment 101 includes one or more data stores 102 configured to store various data that is accessible to the remote server 200 and/or the user computing entity 111, and is used by the network environment 100 to execute various processes and functions discussed herein. The data store 102 can be representative of a plurality of data stores 102 as can be appreciated. The data store 102 can store data such as, but not limited to, user accounts 104, fuel codes 106, identifiers 108, and fuel exchange data 109. In some embodiments, user accounts 104, fuel codes 106, identifiers 108, and fuel exchange data 109 (or subsets thereof) are stored in a memory of the user computing entity 111.

In some embodiments, each user account 104 is associated with a different user entity and/or corresponding user computing entity 111. In some embodiments, the user account 104 includes user credentials for verifying an identity of a user entity or user computing entity 111. Non-limiting examples of user credentials include username, password, biometric information (e.g., facial image, fingerprint scan, voice signature, and/or the like), cryptographic keys (e.g., public-private key pairs), legal name, age, birth date, internet protocol (IP) address, media access control (MAC) address, international mobile equipment identifier (IMEI) number, and/or the like. The user account 104 may include other data associated with a user entity, such as a home address, driver's license number, commercial driver's license (CDL) number, employment status (e.g., independent contractor, self-employed, employee of a particular business, etc.), and/or contact information (e.g., phone number, email address, mailing address, social media accounts, and/or the like). In some embodiments, the user account 104 includes data associated with one or more vehicles owned or operated by a user entity, such as a vehicle registration number, license plate number, vehicle manufacturer, vehicle model, vehicle manufacture year, vehicle service record, vehicle emissions record, and/or the like. In some embodiments, the user account 104 includes data associated with historical fuel events. For example, the user account 104 may include historical fuel exchange amounts, historical fuel exchange ratios, historical fueling locations, historical fuel volumes, and/or the like. In some embodiments, a fuel exchange ratio refers to a cost per unit volume or unit mass for purchasing fuel. For example, a fuel exchange ratio may include a pre- or post-tax dollar purchasing price per gallon of fuel (e.g., or other suitable currency and/or volume unit). In some embodiments, the user account 104, or a subset thereof, is stored in an encrypted format. For example, personally identifiable information (PII) associated with a user entity, or an associated vehicle, may be encrypted such that access thereto requires a dual-authentication process, authentication of a public-private key pair, and/or other security measure.

In some embodiments, the fuel code 106 is a redeemable, revokable token by which a fuel exchange may be initiated and processed on behalf of a user entity and a fuel exchange system 103. The fuel code may be a single-use fuel code that cannot be redeemed more than once. Moreover, the fuel code may be valid for a set duration (e.g., 1 day, 3 days, 2 hours, and/or the like), as defined within data stored in the remote computing environment for the fuel code. Further, in some embodiments, the fuel code may be valid when a user computing entity 111 is at or within a predetermined proximity of a fueling location associated with the fuel exchange system 103 and/or fuel system 112. In various embodiments, the fuel code 106 is a numeric or alphanumeric string. In some embodiments, the fuel code includes a numeric or alphanumeric string of a predetermined format, such as a particular length and/or character combination(s), by which a fuel exchange system may identify the string as a fuel code based at least in part on a storage instruction 116 installed at a fuel exchange system 103. In various embodiments, the fuel code 106 is stored in association with a first identifier for a particular user entity (e.g., such as a user account 104 that includes processing information for an instrument of exchange of the particular user entity) and a second identifier for a particular fuel entity, where the fuel code 106 may be used to authorize and, thereby, initiate and potentially modify, a fuel exchange between the user entity and the fuel entity.

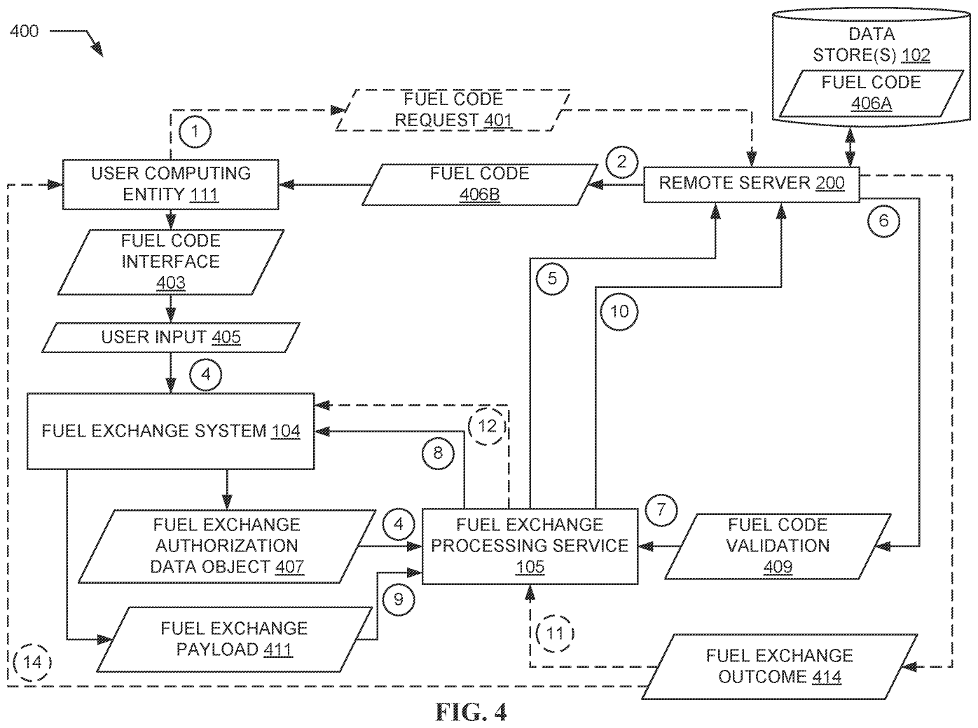

In some embodiments, the identifiers 108 include identifiers for user entities, user computing entities 111, fuel entities, fuel exchange systems 103, fuel exchanges, fuel events, and/or the like. In some embodiments, the fuel exchange data 109 includes data associated with authorizing fuel exchanges including fueling locations, fuel exchange ratios, and associations with identifiers 108 and fuel codes 106. Further exemplary aspects of user accounts 104, fuel codes 106, identifiers 108, and fuel exchange data 109 are described further herein and depicted in the data architecture 400 of FIG. 4.

In some embodiments, the fuel exchange system 103 includes a combination of hardware and software configured to initiate an exchange of value for fuel (e.g., diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, and/or the like). For example, the fuel exchange system 103 may be a point-of-sale (POS) system configured to initiate fuel exchanges and exchanges of value for the fuel exchanges. Additionally, in some embodiments, the fuel exchange system is configured to initiate an exchange of value for additional fuel- or vehicle-related goods and services, such as fuel additives, motor oil, windshield washer fluid, anti-freeze solution, vehicle components, vehicle maintenance, weighing services, and/or the like.

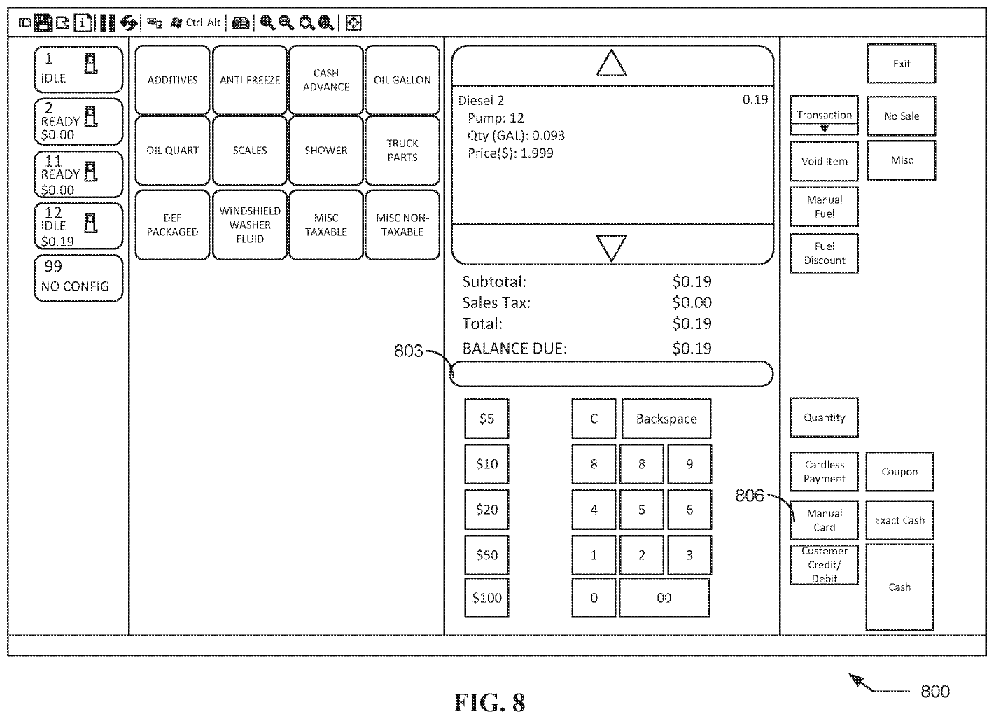

In some embodiments, the fuel exchange system 103 includes one or more input devices 110 configured to receive user inputs. The input device 110 include a keypad (hard or soft), a touch display, voice/speech or motion interfaces, or other input device. In embodiments including a keypad, the keypad can include (or cause display of) the conventional numeric (0-9) and related keys (#, *), and other keys used for operating the fuel exchange system 103 and may include a full set of alphabetic keys or set of keys that may be activated to provide a full set of alphanumeric keys. In some embodiments, the input device 110 includes a fuel exchange software interface rendered on a display of the fuel exchange system 103 or on a computing device in configured to communicate with the fuel exchange system 103 via wired or wireless communication, such as via a network 150. For example, the fuel exchange system 103 includes a GUI 800 as shown in FIG. 8 and described herein.

In some embodiments, the fuel exchange system 103 includes or is configured to communicate with and control one or more fueling systems 112. In some embodiments, the fueling system 112 is a system configured to control access to fuel. For example, the fueling system 112 may be a device, such as a fuel pump, that dispenses fuel to a user entity, a vehicle, and/or a fuel container. In one example, the fueling system 112 may be device that enables and disables a fuel pump handle that controls access to fuel from a fuel pump reservoir. In another example, the fueling system 112 may be a device, such as an adjustable valve, that enables and disables access to a fuel pump reservoir. In another example, the fueling system 112 may include a locking mechanism that enables and disables access to a fuel storage receptacle and/or retrieval of a fuel container. In another example, the fueling system 112 may be a system that reserves or saves an allotment of fuel for collection by a user entity, such as for a wholesale fuel exchange between a fuel supplier and fuel vendor.

In some embodiments, the fueling system 112 is configurable between an inactive state and an active state. In some embodiments, when configured to the inactive state, the fueling system 112 is incapable of or prevents a user entity from dispensing fuel, or otherwise providing access to fuel. In one example, the fueling system 112 is a fuel pump and, in the inactive state, the fuel pump is rendered inoperable for dispensing fuel. In another example, the fueling system 112 is a storage receptacle comprising a locking mechanism and, in the inactive state, the locking mechanism is enabled to prevent opening of the storage receptacle and/or extraction of a fuel container from the storage receptacle. In some embodiments, when configured to the active state, the fueling system 112 allows a user entity to dispense fuel or retrieve fuel from a storage receptacle. For example, the fueling system 112 is a fuel pump and, in the active state, the fuel pump is operable for dispensing fuel. In another example, the fueling system 112 is a storage receptacle comprising a locking mechanism and, in the active state, the locking mechanism is disabled to permit opening of the storage receptacle and/or retrieval of a fuel container from the storage receptacle.

In various embodiments, the remote computing environment 101 provides a validation of a fuel code 106 to the fuel exchange system 103 that causes the fuel exchange system 103 to transition the fueling system 112 from the inactive state to the active state. For example, the remote computing environment 101 may receive and validate a fuel exchange authorization data object indicative of a fuel code 106 (e.g., by comparing the indicated fuel code 106 to a stored fuel code 106). The remote computing environment 101 may provide a validation of the indicated fuel code 106 to the fuel exchange system 103 (e.g., using a fuel exchange processing service and one or more APIs 140). In response to receiving the validation of the indicated fuel code 106, the fuel exchange system 103 may determine that a fuel exchange is authorized and transition a corresponding fueling system 112 from the inactive state to the active state.

In some embodiments, the fuel exchange system 103 stores and runs executable computer instructions (e.g., point-of sale (POS) software, fueling system control program, and/or the like). In some embodiments, by executing the computer instructions, the fuel exchange system controls activation and deactivation of a fueling system 112 by transitioning the fueling system 112 between an inactive state and an active state. In one example, the computer instructions include POS software that, when run by the fuel exchange system 103, allow the fuel exchange system 103 to activate and deactivate one or more fuel pumps at a fueling location based on a fuel exchange. In some embodiments, the computer instructions, when executed, enable the fuel exchange system 103 to transition the fueling system 112 between inactive and active states based on one or more aspects of a fuel exchange. The aspects of the fuel exchange may include a validation of a fuel code, a rejection of a fuel code, a preauthorization limit (e.g., a maximum value of the fuel exchange), a maximum fuel volume, when to allow fueling with or without a maximum fuel volume or preauthorization limit, and/or the like. As described herein, such aspects of a fuel exchange may be determined by the remote computing environment 101 and provided to the fuel exchange system 103 using a fuel exchange processing service 105 and one or more APIs 140. In some embodiments, the computer instructions, when executed, enable the fuel exchange system 103 to generate and render graphical user interfaces on a display provided to an operator of a fueling station. In various embodiments, the graphical user interfaces facilitate receipt of particular types of input data for authorizing a fuel exchange, such as fuel codes 106. An example of such graphical user interfaces is depicted in the fuel exchange software interface 800 shown in FIG. 8 and further described herein.

In some embodiments, the fuel exchange system 103 stores data related to fuel exchanges in a format such that the data is accessible to additional elements of the network environment 100 including the fuel exchange processing service 105, remote computing environment 101, and/or user computing entity 111. In some embodiments, the storing the fuel exchange-related data in such a format includes transforming the data into a data exchange format. For example, the fuel exchange system 103 may generate and store in memory 114 fuel-exchange related data in a Javascript Object Notation (JSON) file format, a comma-separated value (CSV) file format, an extensible markup language (XML) file format, and/or the like.

In some embodiments, the fuel exchange system 103 stores in memory 114 data that is part of an in-progress or completed fuel exchange in a format such that the data may be read or requested from the memory 114 by a fuel exchange processing service 105 and provided to the remote computing environment 101 using one or more APIs 140. In one example, the fuel exchange-related data may include a fuel code 106, or user input indicative thereof. In another example, the fuel exchange-related data may include information associated with an instrument of exchange including a preauthorization limit for the fuel exchange, a current or total fuel exchange amount based on a volume of fuel provided to a user entity, an approved or transacted fuel exchange amount, a remainder fuel exchange amount (e.g., instances of partial approval or rejection of a fuel exchange payload by an administrator of a user's instrument of exchange), and/or the like. In another example, the fuel exchange-related data may include allowances or restrictions on goods or services that may be purchased in addition to the fuel being provided to the user entity, such as purchase eligible or ineligible stock keeping units (SKUs), etc.).

In another example, the fuel exchange-related data may include goods or services registered (e.g., “rung up”) by the fuel exchange system 103 in association with an in-progress fuel exchange. In another example, the fuel exchange-related data includes a type of fuel being provided to the user entity, such as diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, fuel octane level, and/or the like. In still another example, the fuel exchange-related data may include identifying information for a fueling system 112 (e.g., a fuel pump number and/or the like) by which fuel is provide to the user entity. In another example, the fuel exchange-related data may include a current volume of fuel provided during an in-progress fuel exchange, maximum fuel volume for the fuel exchange, total fuel volume provided for a completed fuel exchange, and/or the like. In some embodiments, the fuel exchange system 103 updates and stores the fuel exchange-related data in substantially real-time such that the fuel exchange-related data may be accessed by additional software, systems, or services in substantially real-time throughout and after the associated fuel exchange.

In some embodiments, the fuel exchange system 103 stores and runs software that enables automatic compilation and retrieval of fuel exchange-related data for in-progress and completed fuel exchanges. For example, the fuel exchange system 103 may store and run a software program that defines script and/or queries for generating data objects indicative or inclusive of fuel exchange-related data, including fuel exchange authorization data objects and fuel exchange payloads as described herein. In various embodiments, the software modifies the format of user input data stored by fuel exchange system 103 such that user input data may be recognized as a valid input of exchange instrument data (e.g., though being previously unrecognizable as valid exchange instrument data according to existing and legacy software installed on the fuel exchange system 103). In some embodiments, the software enables the fuel exchange system 103 to store an inputted fuel code 106 in a format such that the fuel code 106 may be recognized by a fuel exchange processing service 105 in communication with the fuel exchange system 103. In some embodiments, the software causes the fuel exchange system 103 to communicate with one or more external computing systems (e.g., fuel exchange processing service 105, remote computing environment 101, and/or user computing entity 111), such as via one or more APIs 140, based on the modified format of the user input. The software may cause the fuel exchange system 103 to temporarily store the user input and provide the user input and additional fuel exchange-related data to the external computing systems via one or more APIs 140. In some embodiments, such software may include or be embodied as a storage instruction 116 installed on and executed by the fuel exchange system 103.

In one example, the fuel exchange system 103 may include a script installed thereon by an operator of the fuel exchange system 103 and/or an administrator entity of the remote computing environment 101. Prior to installation and execution of the script, the fuel exchange system 103 may be limited in function such that the fuel exchange system 103 only recognizes traditional instrument of exchange identifiers, such as credit card numbers, debit card numbers, and/or the like. For example, without the script, the fuel exchange system 103 may interpret a user input for a fuel code 106 as an errant input or unrecognizable character string. When executed by the fuel exchange system 103, the script may cause the fuel exchange system 103 to recognize a user input comprising a fuel code 106 as an identifier for an instrument of exchange. The script may also cause the fuel exchange system 103 to communicate with external computing systems, such as via one or more APIs 140, and, thereby, provide the user input indicative of the fuel code 106 and additional fuel exchange-related data.

In some embodiments, the fuel exchange system 103 is configured to perform various steps/operations of fuel exchange authorization techniques described herein. In some embodiments, the fuel exchange system 103 receives a user input indicative of a fuel code 106. In some embodiments, the fuel exchange system 103 temporarily stores the user input in memory 114 according to one or more storage instructions 116. In some embodiments, the storage instruction 116, when executed by the fuel exchange system 103, causes the fuel exchange system 103 to process a user input and determine whether the user input, or subset of data thereof, matches a predetermined format associated with fuel codes 106. In some embodiments, the fuel exchange system 103 receives the storage instruction 116 from a third-party computing entity via a network 150 or via receipt of and communication with a memory device including the storage instruction 116. In some embodiments, the fuel exchange system 103 generates a fuel exchange authorization object indicative of the user input and provides the fuel exchange authorization object to the remote computing environment 101 using the fuel exchange processing service 105 and one or more APIs 140. For example, the fuel exchange system 103 may transmit the fuel exchange authorization data object to the fuel exchange processing service 105 using a first network 150 and a first API 140. The fuel exchange processing service 105 may relay the fuel exchange authorization data object to the remote computing environment 101 using a second network 150 and a second API 140.

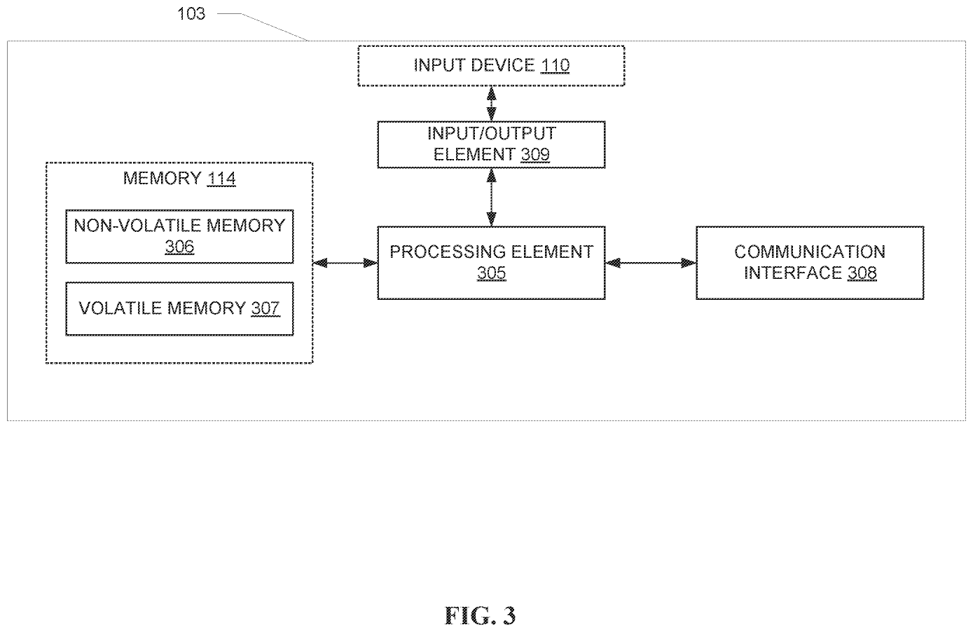

In some embodiments, the fuel exchange system 103 receives a validation of a fuel code 106 indicated by a user input and a fuel exchange authorization data object provided to the remote computing environment 101. In some embodiments, in response to receiving the validation of the fuel code, the fuel exchange system 103 activates a fueling system 112, such as by transmitting a fuel start code that transitions the fueling system 112 from an activate state to an inactive state. In some embodiments, the fuel exchange system 103 generates or receives from the fueling system 112 fuel event data, such as a fuel volume, fuel exchange amount, and/or fueling start and stop time. In some embodiments, the fuel exchange system generates a fuel exchange payload based on the fuel event data. The fuel exchange payload may indicate the fuel exchange amount and additional fuel event data or fuel exchange data as further described herein. Further description of exemplary functions provided and actions performed by the fuel exchange system 103 are described herein with reference to FIGS. 3, 4, and 6.

In some embodiments, the fuel exchange system 103 includes memory 114 configured to store various data that is accessible to the fuel exchange system 103 to execute various processes and functions discussed herein. In some embodiments, the memory 114 includes one or more storage instructions 116. In some embodiments, the memory 114 temporarily stores a user input indicative of a fuel code, a fuel exchange authorization data object, fuel exchange payload, and/or a fuel exchange outcome, such as when the data is modified from an original format according to one or more scripts. In some embodiments, the memory 114 stores, for a lengthier period or until manual or other software-defined deletion, a user input indicative of a fuel code, a fuel exchange authorization data object, fuel exchange payload, and/or a fuel exchange outcome in an original format.

In some embodiments, the fuel exchange system 103 includes one or more storage instructions 116 that define one or more scripts executable by the fuel exchange system 103, or a storage computing system in communication therewith, to recognize and reformat a user input indicative of a fuel code, a fuel exchange authorization data object, fuel exchange payload, and/or a fuel exchange outcome. In some embodiments, the remote computing environment 101 and/or fuel exchange processing service include storage instructions 116 that define other scripts for recognizing and reformatting fuel codes, fuel exchange authorization data objects, fuel exchange payloads, and/or fuel exchange outcomes. In some embodiments, a script defined by a storage instruction 116 automatically convert the fuel codes, fuel exchange authorization data objects, and/or fuel exchange payloads into a data format that may be provided to or extracted by the fuel exchange processing service 105 or provided to the remote computing environment 101. In some embodiments, a script defined by a storage instruction 116 reformats fuel codes, fuel exchange authorization data objects, and/or fuel exchange payloads by concatenating one or more characters, truncating one or more characters, replacing one or more characters of, and/or adding one or more characters to, the fuel code, fuel exchange authorization data object, and/or fuel exchange payload. In some embodiments, the script performs reformatting in a standardized manner. In alternate embodiments, the script reformats each of a fuel code, fuel exchange authorization data object, and/or fuel exchange payload in a manner unique to the fuel code, fuel exchange authorization data object, and/or fuel exchange payload. In some embodiments, the script generates a format by which perform reformatting based on a fuel code.

In some embodiments, the storage instruction 116 causes the fuel exchange system 103 to temporarily stores fuel codes, fuel exchange authorization data objects, and/or fuel exchange payloads for periods sufficient to allow the script to reformat and provide the fuel code, fuel exchange authorization data object, and/or fuel exchange payload to the fuel exchange processing service 105. In some embodiments, following the period and/or providing of the fuel code, fuel exchange authorization data object, and/or fuel exchange payload to the fuel exchange processing service 105, the storage instruction 116 causes the fuel exchange system 103 to delete the format-modified fuel code, fuel exchange authorization data object, and/or fuel exchange payload from memory such that the modified data does not interfere with existing operations of the original software (e.g., native point of sale software) running on the fuel exchange system 103.

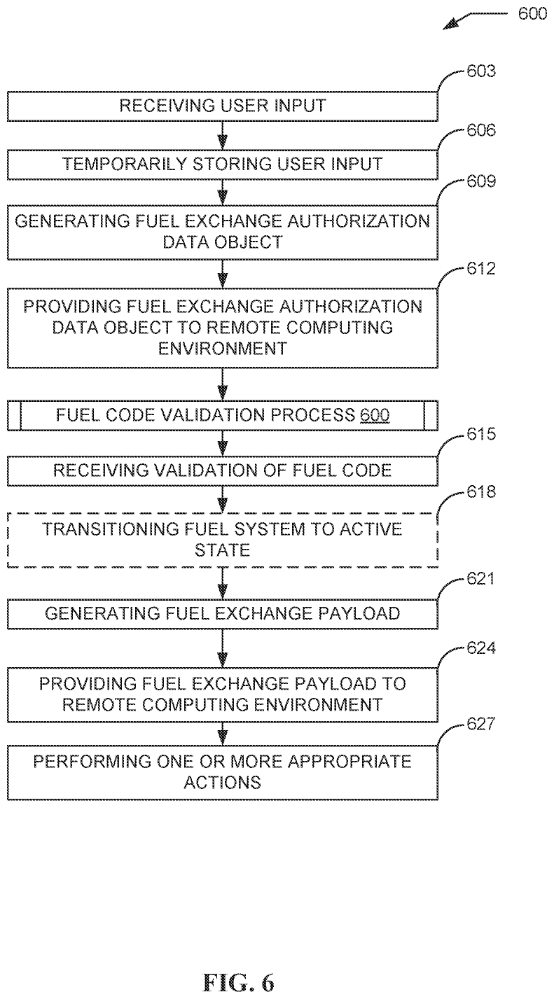

In some embodiments, the fuel exchange processing service 105 processes exchanges of value and/or data related to an exchange of value, such as a user input indicative of a fuel code, a fuel exchange authorization data object, a fuel exchange payload, and/or a fuel exchange outcome. For example, the fuel exchange processing service 105 processes credit card transactions, debit card transactions, bank-affiliated account transactions, non-bank affiliated account transactions, cryptographic asset related transactions, and/or the like. The fuel exchange processing service 105 may be representative of a plurality of different fuel exchange processing services 105, where each fuel exchange processing service 105 may perform different types of exchange processing and/or communicate with different fuel exchange systems 103. In some embodiments, the fuel exchange processing service 105 relays data between the fuel exchange system 103 and the remote computing environment 101 using one or more APIs 140. In some embodiments, the fuel exchange processing service 105 executes one or more scripts for reformatting data from an original format associated with a fuel exchange system 103 (or an initial modified format associated with a script executed by the fuel exchange system 103 or remote computing environment 101) to a modified format associated with the remote computing environment 101 (or a secondary modified format associated with the fuel exchange system 103 or a transaction processing environment with which the fuel exchange processing service 105 communicates). Further description of exemplary functions provided and actions performed by the fuel exchange processing service 105 are described herein with reference to FIGS. 4, and 6.

Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Exemplary User Computing Entity

A user entity may interact with a user computing entity 111 via a user interface thereon, and/or the user entity may interact with a user computing entity 111 to obtain information/data regarding a user account 104, one or more fuel codes 106, one or more identifiers 108, fuel exchange data 109, and/or an instrument of exchange associated with a user entity. As will be recognized, an instrument of exchange associated with a user entity, user account 104, and/or user computing entity 111 may be any of a number of different instrument types, including a credit instrument, debit instrument, cryptographic asset wallet, bank-administrated financial account, non-bank-administered financial account, and/or the like.

A credit instrument may include a credit card associated with a credit account administered by a financial institution or other credit-providing entity that can provide payments on behalf of a user entity, and to which the user entity is obligated to reimburse for such payments. A debit instrument may include a debit card associated with a user entity's checking account, savings account, or other deposit account and by which payments may be made on behalf of the user entity via transfer of assets out of the corresponding deposit account using the debit instrument to verify the transfer. A bank-administered financial account may include a bank-administered checking account, savings account, money market account (MMA), certificate of deposit account (CD), and/or the like, that holds financial assets of a user entity and by which payments may be made on behalf of the user via electronic funds transfer (EFT), such as via an automated clearing house (ACH). A non-bank-administered financial account may be a financial account associated with a non-banking entity that holds financial assets on behalf of a user entity and by which payments may be made on behalf of the user entity via transfer of the financial assets via a payment platform. Non-limiting examples of a non-bank-administered financial account include digital wallets (e.g., PayPal, Venmo, Zelle, and/or the like), accounts on stock or commodity trading platforms, accounts on person-to-person or business-to-business lending platforms, and/or the like. A cryptographic asset wallet may include a device, physical medium, program, or service that stores public and/or private keys for authorizing transfers of cryptographic assets (e.g., Bitcoin, Ethereum, Tether, and/or the like) via a distributed ledger service, such as a blockchain protocol or smart contract (e.g., Bitcoin protocol, Ethereum network, TRON network, etc.).

In some embodiments, the user computing entity 111 includes one or more components that are functionally similar to those of the remote server 200. As noted previously, the terms device, system, computing entity, entity, server, and/or similar words used herein interchangeably may refer to at least, for example, one or more computers, computing entities, mobile phones, tablets, phablets, watches, glasses, car pieces, wristbands, wearable items/devices, fobs, other internet-of-things (IoT) devices, and/or the like, and/or any combination of devices or entities adapted to perform the functions, operations, and/or processes described herein. In some embodiments, the user computing entity 111 includes one or more displays 118, one or more input devices 120, an application 122, and memory 124. In some embodiments, the user computing entity 111 includes an antenna 126, a transmitter 128 (e.g., radio), a receiver 130 (e.g., radio), and a processing element 132 (e.g., CPLDs, microprocessors, multi-core processors, cloud processors, coprocessing entities, ASIPs, microcontrollers, and/or controllers) that provides signals to and receives signals from the transmitter 128 and receiver 130, respectively.

In one embodiment, the signals provided to and received from the transmitter 128 and the receiver 130, respectively, may include signaling information/data in accordance with air interface standards of applicable wireless systems. In this regard, the user computing entity 111 may be capable of operating with one or more air interface standards, communication protocols, modulation types, and access types. More particularly, the user computing entity 111 may operate in accordance with any of a number of wireless communication standards and protocols, such as those described above with regard to the remote server 200 or fuel exchange system 103. In a particular embodiment, the user computing entity 111 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 111 may operate in accordance with multiple wired communication standards and protocols, such as those described above with regard to the remote server 200, fuel exchange system 103, and/or fuel exchange processing service 105 via a network 150.

Via these communication standards and protocols, the user computing entity 111 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). In one embodiment, the user computing entity 111 can also download changes, add-ons, and updates, for instance, to its firmware, software (e.g., including executable instructions, applications, program modules), and operating system.

According to one embodiment, the user computing entity 111 may include location determining aspects, devices, modules, functionalities, and/or similar words used herein interchangeably. For example, the user computing entity 111 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). In one embodiment, the satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the user computing entity 111 in connection with a variety of other systems, including cellular towers, Wi-Fi access points, and/or the like. Similarly, the user computing entity 111 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, Bluetooth Smart, Wi-Fi Direct transmitters, NFC transmitters, and/or the like. These indoor positioning aspects can be used in a variety of settings to determine the location of someone or something to within inches or centimeters.

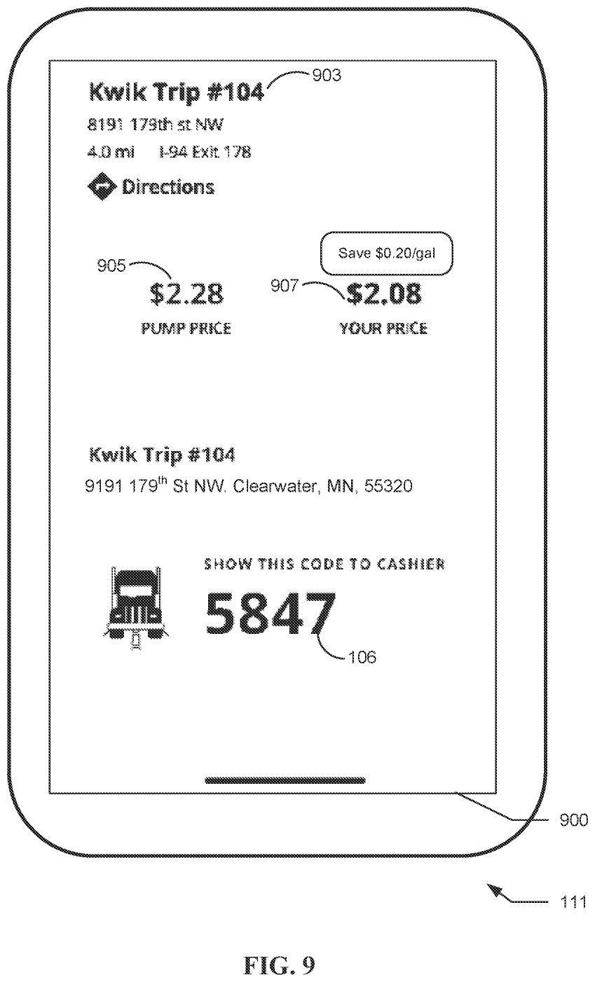

In some embodiments, the user computing entity 111 includes an application 122 that accesses services and functions of the remote computing environment 101. For example, the user computing entity 111 may communicate with the remote computing environment 101 using the application 122. In some embodiments, the application 122 transmits request for generation and receipt of fuel codes 106 to the remote computing environment 101. For example, the application 122 causes the user computing entity 111 to generate a graphical user interface by which a user entity may provide a user input for requesting generation and receipt of a fuel code 106 for a fueling location associated with a fuel entity. In response to the user computing entity 111 receiving the user input, the application 122 may generate and transmit to the remote computing environment 101 a fuel code request including the fueling location, an identifier for the fuel entity, a timestamp of the user input, a location of the user computing entity 111, and/or a current fuel exchange ratio associated with the fueling location and/or fuel entity. In some embodiments, the application 122 receives a fuel code 106 from the remote computing environment 101 and stores the fuel code 106 in memory 124 of the user computing entity 111. In some embodiments, the application 122 accesses a network address, such as a webpage, at which a fuel code 106 may be downloaded or obtained and rendered on a display 118 of the user computing entity 111. In some embodiments, the application 122 causes the user computing entity 111 to generate and render graphical user interfaces for requesting a fuel code 106, displaying a location of the user computing entity 111, displaying a location of one or more fueling locations, displaying a fuel exchange ratio for one or more fueling locations, accessing and displaying information associated with a user account 104, accessing and displaying historical fuel exchange data 109, and/or the like. An example graphical user interface that may be generated by the application 122 and rendered on the user computing entity 111 is depicted by the graphical user interface 900 shown in FIG. 9 and described herein.

In one example, the application 122 communicates with the remote computing environment 101 to receive geolocation data indicative of a location of one or more fueling locations. The application 122 may cause the user computing entity 111 to generate and render a graphical user interface including a map on which the locations of the one or more fueling locations are rendered. In another example, the application 122 communicates with the remote computing environment 101 to receive a current fuel exchange ratio for one or more fueling locations. The current fuel exchange ratio may be a discounted price per volume fuel price available to user entities by providing a fuel code 106 to the fuel exchange system 103 associated with the fueling location.

In some embodiments, the application 122 interfaces with other software or applications installed or running on the user computing entity 111. Such software may include geolocation software, Internet browsing software, image capture software, user authentication software, and software that manages or provides access to information associated with a user entity's instrument of exchange (e.g., credit cards, debit cards, banking accounts, cryptographic asset wallets, and other payment instruments). In one example, the application 122 interfaces with a navigation application to determine and provide a location of the user computing entity 111 to the remote computing environment 101 and/or generate a graphical user interface including a virtual map that displays the location and one or more fueling locations. In another example, the application 122 interfaces with a payment instrument management application to obtain and provide to the remote computing environment 101 various data associated with the user entity's instrument of exchange (e.g., credit card number, expiration data, card verification value, and/or the like).

In one embodiment, the user computing entity 111 may also comprise a user interface 117 (that can include a display 118 coupled to a processing element 132), which may include user input interface (coupled to a processing element 132). For example, the user interface 117 may be an application 122, browser, user interface, interface, and/or similar words used herein interchangeably executing on and/or accessible via the user computing entity 111 to interact with and/or cause display of information/data from the remote server 200, as described herein. The user input interface can comprise any of input devices 120 allowing the user computing entity 111 to receive data, such as a keypad (hard or soft), a touch display, voice/speech or motion interfaces, or other input device. In embodiments including a keypad, the keypad can include (or cause display of) the conventional numeric (0-9) and related keys (#, *), and other keys used for operating the user computing entity 111 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

In certain embodiments, the user interface (e.g., the display 118) may be configured for displaying fuel codes that may be provided or presented to a fuel exchange system 103 to initiate and enable authorization of a fuel exchange. For example, the user interface of the user computing entity 111 may be utilized to display a QR code, a bar code, an image, and/or the like that is machine-readable and indicative of a fuel code. Similarly, the user computing entity 111 may be configured for storing fuel codes 106 thereon, and transmitting inputs indicative of fuel codes 106 via any of a variety of wireless data transmission protocols (e.g., Bluetooth, Wi-Fi, NFC, and/or the like) to the fuel exchange system 103.

In some embodiments, the user computing entity 111 includes memory 124, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The memory 124 may include volatile memory and/or non-volatile memory. The memory 124 can store databases, database instances, database management systems, data, applications, programs, program modules, scripts, source code, object code, byte code, compiled code, interpreted code, machine code, executable instructions, and/or the like to implement the functions of the user computing entity 111. The memory 124 can store fuel codes 106, data associated with a user account 104, identifiers 108, and/or fuel exchange data 109. As indicated, this may include an application 122 that is resident on the user computing entity 111 or accessible through a browser or other user interface for communicating with the remote server 200, fuel exchange system 103, and/or various other computing entities.

As will be recognized, the user computing entity 111 may include one or more components or functionality that are the same or similar to those of the remote server 200, as described in greater detail below. As will be recognized, these architectures and descriptions are provided for exemplary purposes only and are not limiting to the various embodiments.

### Exemplary Networks

In one embodiment, any two or more of the illustrative components of the architecture of FIG. 1 may be configured to communicate with one another via respective communicative couplings to one or more networks 150. The networks 150 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 150 may have any suitable communication range associated therewith and may include, for example, global networks (e.g., the Internet), metropolitan area networks (MANs), wide area networks (WANs), local area networks (LANs), or personal area networks. In addition, the networks 150 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Transmissions over networks 150 may be “in the clear” or may leverage one of more of a variety of industry-standard or third-party security technologies implemented in any of the OSI layers used. If encryption is used, it may be symmetric or asymmetric (or implement a combination of the two, as in SSL/TLS, where the initial handshake uses asymmetric encryption in the exchange of symmetric keys, and subsequent transactions use symmetric encryption based on the previously exchanged symmetric keys). As will be recognized, process interaction over a network may be synchronous or asynchronous: synchronous-processes are coupled and include web services (e.g., SOAP), which may in turn leverage http(s); and various other remote procedure call (RPC), middleware protocols, industry-standard exchange formats (e.g., XML or JSON), and integration architectures (e.g., REST) and/or asynchronous-processes are decoupled and mechanisms include message queues and file transfers.

### Exemplary Remote Server

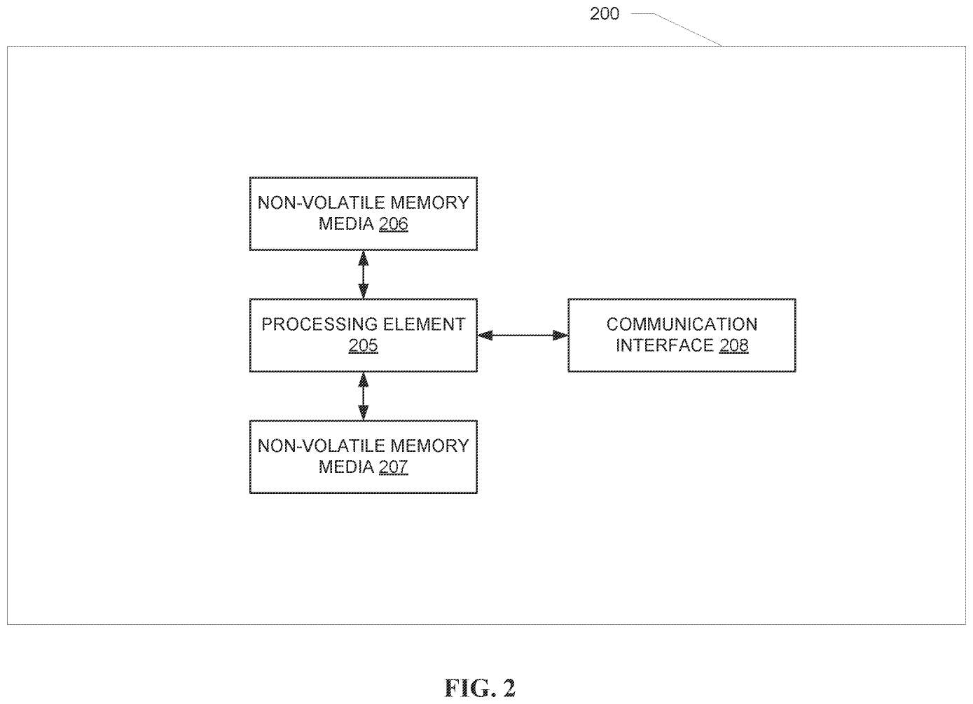

FIG. 2 provides a schematic of a remote server 200 according to one embodiment of the present techniques for fuel exchange authorization and optimization. In one embodiment, the remote server 200 may be in network communication with one or more user computing entities 111, one or more fuel exchange processing services 105, one or more computing systems associated with administrating and/or issuing an instrument of exchange, and/or the like. In certain embodiments, the remote server 200 may be operable in association with other computing devices and/or platforms (e.g., operable via third parties, such as banking institutions' online banking platforms) to accomplish certain functions (e.g., user authentication) to retrieve certain data, and/or the like. In general, the terms computing entity, computer, entity, device, system, server, machine, and/or similar words used herein interchangeably may refer to, for example, one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In one embodiment, the remote server 200 may include or be in communication with one or more one or more processing elements 205 (also referred to as processors, processing circuitry, processing device, and/or similar terms used herein interchangeably) that communicate with other elements within the remote server 200 via a bus, for example. In certain embodiments, the processing element may access various data to perform functions of the remote server 200, such as user accounts (e.g., user (login) ID, password (or other authentication credential(s), user name, user registration status, and/or the like), fuel codes, identifiers, fuel exchange data, and/or the like. As will be understood, the processing element 205 may be embodied in a number of different ways. For example, the processing element 205 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile memory or otherwise accessible to the processing element 205. As such, whether configured by hardware or computer program products, or by a combination thereof, the processing element 205 may be capable of performing steps or operations according to embodiments of the present techniques for fuel exchange authorization and optimization when configured accordingly.

In one embodiment, the remote server 200 may further include or be in communication with non-volatile memory 206 (also referred to as non-volatile storage, memory, memory storage, memory circuitry and/or similar terms used herein interchangeably), which may include or be embodied as one or more data stores 102. In one embodiment, the non-volatile storage or memory may include one or more non-volatile storage or memory media 206, including but not limited to hard disks, ROM, PROM, EPROM, EEPROM, flash memory, MMCs, SD memory cards, Memory Sticks, CBRAM, PRAM, FRAM, NVRAM, MRAM, RRAM, SONOS, FJG RAM, Millipede memory, racetrack memory, and/or the like. As will be recognized, the non-volatile storage or memory media 206 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In one embodiment, the remote server 200 may further include or be in communication with volatile memory 207 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 207, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the remote server 200 with the assistance of the processing element 205 and operating system.

As indicated, in one embodiment, the remote server 200 may also include one or more communications elements/interfaces 208 for communicating with various computing entities, such as by communicating data, content, information, and/or similar terms used herein interchangeably that can be transmitted, received, operated on, processed, displayed, stored, and/or the like. For instance, the remote server 200 may communicate with one or more networks 150, one or more user computing entities 111, one or more fuel exchange systems 103, one or more fuel exchange processing services 105, one or more computing systems associated with administration or issuance of an instrument of an exchange (e.g., banking institutions, credit and/or debit card networks, cryptographic asset environments, such as blockchains, etc.), and/or the like.

In certain embodiments, the remote server 200 may be configured to authorize fuel exchanges based at least in part on receipt and processing of data as described herein. For example, the remote server 200 may generate, store, and provide a fuel code to a user computing entity 111. The remote server 200 may receive fuel exchange authorization data objects indicative of a fuel code. The remote server 200 may validate the received fuel code against stored fuel codes, where the validation of the fuel code may be provided to a fuel exchange system. The remote server 200 may receive a fuel exchange payload generated by the fuel exchange system respective to a fuel event, where the fuel exchange payload indicates a fuel exchange amount. The remote server 200 may authorize and initiate an exchange of value for the fuel exchange amount using a user entity's instrument of exchange. Thus, the remote server may enable authorization and initiation of fuel exchanges without exposing sensitive information for the instrument of exchange to the fuel exchange system (e.g., also eliminating a need for a user entity to present such information to an operator of the fuel exchange system).

As indicated, in one embodiment, the remote server 200 may also include one or more communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the remote server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The remote server 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP). Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Although not shown, the remote server 200 may include or be in communication with one or more input elements, such as a keyboard input, a mouse input, a touch screen/display input, motion input, movement input, audio input, pointing device input, joystick input, keypad input, and/or the like. In one embodiment, the remote server 200 may also include or be in communication with one or more output elements (not shown), such as audio output, video output, screen/display output, motion output, movement output, and/or the like.

As will be appreciated, one or more of the components of the remote server 200 may be located remotely from other remote server 200 components, such as in a distributed system. Furthermore, one or more of the components may be combined and additional components performing functions described herein may be included in the remote server 200. Thus, the remote server 200 can be adapted to accommodate a variety of needs and circumstances. As will be recognized, these architectures and descriptions are provided for exemplary purposes only and are not limiting to the various embodiments.

### Exemplary Fuel Exchange System

FIG. 3 provides a schematic of a fuel exchange system 103 according to one embodiment of the present techniques for fuel exchange authorization and optimization. In one embodiment, the fuel exchange system 103 may be in network communication with one or more user computing entities 111, one or more fuel exchange processing services 105, one or more computing systems associated with administrating and/or issuing an instrument of exchange, and/or the like. In certain embodiments, the fuel exchange system 103 may be operable in association with other computing devices and/or platforms (e.g., operable via third parties, such as banking institutions' online banking platforms) to accomplish certain functions (e.g., receiving user input, generating and providing fuel exchange authorization data objects and fuel exchange payloads, receiving validations of fuel codes, etc.) to retrieve or provide certain data, and/or the like.

In various embodiments, the fuel exchange system 103 includes or embodies one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. For example, the fuel exchange system 103 may receive user inputs indicative of fuel codes and other fuel exchange-related data, such as an identifier for a fueling system by which fuel may be provided to a user entity. As another example, the fuel exchange system 103 may control a fueling system, such as by transitioning a fueling system between inactive and active states, based on data received from a remote computing environment via a fuel exchange processing service and one or more APIs. In another example, the fuel exchange system 103 processes a user input based on a storage instruction and determines that the user input includes a format corresponding to a fuel code payment type. In another example, in response to recognizing a user input as indicative of a fuel code, the fuel exchange system transforms the user input into a data format by which the user input may be transmitted to or collected by a fuel exchange processing service and provided to a remote computing environment using one or more APIs. In one embodiment, these functions, operations, and/or processes can be performed on data, content, information, and/or similar terms used herein interchangeably.

In one embodiment, the fuel exchange system 103 may include or be in communication with one or more processing elements 305 (also referred to as processors, processing circuitry, processing device, and/or similar terms used herein interchangeably) that communicate with other elements within the fuel exchange system 103 via a bus, for example. In certain embodiments, the processing element 305 may access or receive data associated with performing functions described herein, such as user inputs, fuel codes, validations or rejections of fuel codes, fuel exchange-related data (e.g., fuel exchange ratios, fuel volumes, fuel volume limits, fuel types), and/or the like. As will be understood, the processing element 305 may be embodied in a number of different ways. For example, the processing element 305 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in memory 114 (e.g., in volatile or non-volatile memory) or otherwise accessible to the processing element 305. As such, whether configured by hardware or computer program products, or by a combination thereof, the processing element 305 may be capable of performing steps or operations according to embodiments of the present techniques for fuel exchange authorization and optimization when configured accordingly. In various, functions of the processing element 305, and/or other elements of the fuel exchange system 103, are modified according to storage instructions. Such storage instructions, when executed by the processing element 305, may enable the fuel exchange system 103 to recognize user input for fuel codes as a valid identifier for an instrument of exchange. When executed by the processing element 305, the storage instructions may also cause the fuel exchange system 103 to transform such user input, and potentially other fuel exchange-related data, into a format by which the user input may be provided to or collected by an external computing system, such as via one or more APIs.

In one embodiment, the fuel exchange system 103 may further include or be in communication with non-volatile memory 306 (also referred to as non-volatile storage, memory, memory storage, memory circuitry and/or similar terms used herein interchangeably), which may include or be embodied as memory 114. In one embodiment, the non-volatile storage or memory may include one or more non-volatile storage or memory media 306, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 306 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like. In some embodiments, the non-volatile memory 306 stores storage instructions 116 that cause the processing element 305 to modify a format of user input data stored at the fuel exchange system 103 to enable performance of functions described herein for remotely initiating and executing fuel exchanges based on user inputs indicative of fuel codes.

In one embodiment, the fuel exchange system 103 may further include or be in communication with volatile memory 307 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 307, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the fuel exchange system 103 with the assistance of the processing element 305 and operating system. In some embodiments, the volatile memory 307 temporarily stores user inputs according to a storage instruction 116. For example, in response to the processing element 305 recognizing a user input as indicating a fuel code (e.g., via execution of the storage instruction 116), the volatile memory 307 temporarily stores the user input according to the storage instruction 116.

As indicated, in one embodiment, the fuel exchange system 103 may also include one or more communications elements/interfaces 308 for communicating with various computing entities, such as by communicating data, content, information, and/or similar terms used herein interchangeably that can be transmitted, received, operated on, processed, displayed, stored, and/or the like. For instance, the fuel exchange system 103 may communicate with one or more networks 150, one or more user computing entities 111, a remote computing environment 101, one or more fuel exchange processing services 105, one or more fueling systems 112, one or more computing systems associated with administration or issuance of an instrument of an exchange (e.g., banking institutions, credit and/or debit card networks, cryptographic asset environments, such as blockchains, etc.), and/or the like.

In some embodiments, the fuel exchange system 103 includes one or more input/output elements 309 that receive an indication of a user input and, in some embodiments, provide an output or input to one or more computing devices. In some embodiments, the input/output element 309 embodies or communicates with the input device 110. For example, the input/output element 309 provides output to and receives input from one or more computing devices (e.g., user computing entities 111, input devices 110, and/or the like). In one example, the input/output element 309 receives a user input indicative of a fuel code, a fuel type, a fueling system, and/or the like. In some embodiments, the input/output element 309 provides user inputs to the processing element 305. The input/output element 309 may comprise one or more fuel exchange software interface(s) and in some embodiments includes a display that comprises the interface(s) rendered as a web user interface, an application user interface, a user device, a backend system, or the like. In some embodiments, the input/output element 309 also includes a keyboard, a mouse, a joystick, a touch screen, touch areas, soft keys a microphone, a speaker, and/or other input/output mechanisms.

In certain embodiments, using the processing element 305, memory 114, communication interface 308, and input/output element 309, the fuel exchange system 103 may be configured to obtain authorization for fuel exchanges based at least in part on receipt and processing of data as described herein. For example, the fuel exchange system 103 may receive a user input, determine the user input indicates a fuel code, and transform the user input into a format by which a fuel exchange processing service 105 may obtain the user input and provide the user input to a remote computing environment 101. The fuel exchange system 103 may receive a validation of the fuel code from the remote computing environment 101 via a relay of the validation by the fuel exchange processing service 105 using one or more APIs. The validation of the fuel code, or additional received data, may indicate a fuel exchange ratio by which a fuel exchange amount (e.g., cost) for the fuel exchange may be determined. The validation of the fuel code may cause the fuel exchange system 103 to transition a fueling system from an inactive state to an active state (e.g., potentially based additional fuel exchange data received, such as a fuel volume limit, preauthorization limit, and/or the like). The fuel exchange system 103 may determine a fuel volume and generate a fuel exchange amount based on the fuel volume and a fuel exchange ratio. The fuel exchange system 103 may generate a fuel exchange payload indicative of the fuel exchange amount and provide the fuel exchange payload to the remote computing environment 101 via a relay of the fuel exchange payload by the fuel exchange processing service 105 using one or more APIs. The fuel exchange system 103 may receive an outcome of the fuel exchange amount from the remote computing environment in a similar manner.

As indicated, in one embodiment, the fuel exchange system 103 may also include one or more communications interfaces 308 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the fuel exchange system 103 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The fuel exchange system 103 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the components of the fuel exchange system 103 may be located remotely from other fuel exchange system 103 components, such as in a distributed system. Furthermore, one or more of the components may be combined and additional components performing functions described herein may be included in the fuel exchange system 103. Thus, the fuel exchange system 103 can be adapted to accommodate a variety of needs and circumstances. As will be recognized, these architectures and descriptions are provided for exemplary purposes only and are not limiting to the various embodiments.

### Technical Challenges

As previously indicated, obtaining fuel (e.g., vehicle fuel, such as diesel fuel for long-haul truckers) from a fueling station has historically required that a party obtaining the fuel be present at fueling station to initiate a desired exchange of fuel by providing payment instrument data, such as a credit card, debit card, and/or the like. The requirement of physical party presence and furnishing of a payment instrument at the fueling station to initiate fuel exchanges may decrease efficiency of transporting goods due to increased time required to complete a fuel stop. Existing fueling systems lack the capability to interface with and be controlled by a remote computing environment and replacement of such fueling systems may be cost prohibitive due to such activities creating undesirable disruptions to fueling services and the reliance of existing fueling systems on legacy computing infrastructure and software that are no longer maintained or updated. As a result, technical challenges of providing remote access functionality at fueling stations may require specially configured computing solutions that work within and accommodate for limitations of legacy fuel exchange systems. However, due in part to abundant diversity in software schemas and hardware configurations, effective solutions must be backwards compatible with a wide variety of fuel exchange systems.

Further technical challenges to improving previous approaches are introduced by a need to accommodate for fuel exchanges that involve multiple product types and/or multiple alternative products. For example, a fuel exchange may be a transaction for one of a plurality of different fuel types being offered at fueling station. Additionally, or alternatively, a fuel exchange may be a transaction for a volume of fuel and additional non-fuel products or services, such as parts, fluids, maintenance, and/or the like. Initiation, authorization, and/or processing of such fuel exchanges may require identification and differentiation of different product types. However, within the wide variety of legacy software schemas and hardware configurations for managing fuel exchanges, there is not a consistent format by which transactional data is generated and provided such that multiple product types and/or alternative products may be differentiated and identified. As a result, such implementation-specific product differentiation concerns may conflict with requirements for generalized, backwards-compatible solutions to configuring remote fuel exchange initiation capabilities within the wide variety of existing fuel exchange systems.

### Technical Solutions

Inventors in the present disclosure have developed technical solutions enabling remote fuel exchange initiation at fuel exchange systems, which overcome the above technical challenges and, thereby, improve the performance of fuel exchange systems. As described herein, such technical solutions include manipulating formats of data stored at the fuel exchange system without manipulating software of the fuel exchange system itself. The manipulated data may be user input data, which historically includes payment instrument data, such as credit card numbers, debit card numbers, and/or the like. Using the techniques of the present disclosure, user input data may be manipulated such that a fuel exchange system may accept, as compatible payment instrument data, a fuel code that is more universally acceptable for and/or specifically usable to external computing systems, such as the remote computing environment described herein. For example, a customer may provide a fuel code to a cashier at a fueling station. The cashier may input, to a fuel exchange system, user input data indicative of the fuel code. The user input data may be transformed to a format such that the user input data may be stored temporarily in memory of the fuel exchange system, as would occur with traditional payment instrument data (e.g., credit card numbers, and/or the like). Simultaneously, the transformed format of the user input data may render the user input data recognizable to an external computing system configured to receive or retrieve (e.g., scrape) payment instrument data from the fuel exchange system, such as a transaction (fuel exchange) processing service. The external computing system may enable a remote computing environment to intercept the user input data, and potentially other fuel exchange data (e.g., fuel type, fueling location, fuel entity identifiers, etc.) before and instead of the user input being provided to a traditional payment instrument entity for validation.

The remote computing environment may receive the user input data and match the user input data to a stored record for validation. For example, the remote computing environment may compare and match a fuel code indicated by the user input data to a stored fuel code. The remote computing environment may provide a validation of the user input data to the fuel exchange system (e.g., using a fuel exchange processing service and one or more APIs) without the fuel exchange system receiving and providing payment instrument data to a transaction processing service. By modifying the format of stored user input data at the fuel exchange system such that the data may be provided to the remote computing environment, the fuel exchange system may be remotely commanded and authorized to initiate a fuel exchange without the customer and cashier engaging in a time-consuming and, thereby, inefficient interaction of physically providing, inputting, and awaiting approval of a traditional payment instrument after arrival at the fueling station. In other words, the present systems and processes may overcome the above technical challenges by enabling advance request to initiate a fuel exchange and remotely initiating the fuel exchange by receiving user input data indicative of the request.

Furthermore, the remote computing system may interface with the customer via the customer's computing device (user entity device) to obtain and store traditional payment instrument data by which payment for a fuel exchange may be obtained. Following a fuel event and validation of the user input data, the remote computing system may receive a fuel exchange payload generated by the fuel exchange system (e.g., instead of the fuel exchange system providing a transaction payload to a traditional payment instrument administrator). The remote computing system may supplement the fuel exchange payload with the traditional payment instrument data of the customer and communicate with a corresponding payment instrument administrator and/or transaction processing network to complete payment for the fuel exchange. The remote computing system may also receive inputs from the customer's computing device that indicate products or services associated with the fuel exchange, thereby enabling the remote computing system to distinguish between and indicate, to a payment instrument administrator, different types of products and services associated with the fuel exchange. By supplementing the fuel exchange data with additional product and service information as received or determined from user inputs, the remote computing environment may enable recognition and differentiation of products, even where the fuel exchange system does not output data indicating different types of products and services involved in a fuel exchange.

In various embodiments, as described above, the present systems and methods enable remote initiation of fuel exchanges at an existing fuel exchange system without modifying the software of the fuel exchange system. As a result, the fuel exchange system retains the ability to automatically activate a fueling system even though primary functions of the fuel exchange system software that traditionally underlie activation of a fueling system (e.g., receipt and validation of payment instrument data) are circumvented. As a further advantage, from the perspective of the fueling station and operator of the fuel exchange system, the present systems and methods allow the fuel exchange system to be operated in a traditional manner without changes to graphical user interfaces utilized by the operator to perform fuel exchange tasks. As a result, the present systems and methods provide a technical solution for enabling remote initiation of fuel exchanges without requiring reconfiguration of fuel exchange software, reconfiguration of associated graphical user interfaces, or retraining of fuel exchange operators.

### Example Operation

FIG. 4 provides an example data flow 400 for authorizing a fuel exchange according to certain embodiments. In various embodiments, a sequence of the data flow 400 is indicated in FIG. 4 by numerical indicia 1-13. In some embodiments, one or more operations of the data flow 400 are combined or omitted.

In some embodiments, a remote server 200 receives from a user computing entity 111 a fuel code request 401 (see indicium 1). The fuel code request 401 may be generated and provided to the remote server 200 in response to the user computing entity 111 receiving a user input provided to an executable software application on the user computing entity 111. In a particular example, the fuel code request 401 is generated and provided to the remote server 200 in response to an application 122 (e.g., installed on or accessed by the user computing entity 111) receiving a user input to a graphical user interface. The fuel code request 401 may include an identifier associated with the user computing entity 111, a user entity, and/or a user account at a data store 102 accessible to the remote server 200. The fuel code request 401 may include an identifier associated with a fuel entity, fueling location, and/or fuel exchange system at which a user entity desires to initiate a fuel exchange.

In some embodiments, in response to the fuel code request 401, the remote server 200 generates a fuel code 406A, 406B. The remote server 200 may store the fuel code 406A at the data store 102 in association with an identifier for the fuel entity, fueling location, and/or fuel exchange system. Additionally, or alternatively, the remote server 200 may store the fuel code 406A in association with an identifier for the user computing entity 111, a corresponding user entity, and/or a user account. In some embodiments, the remote server 200 associates the fuel code 406A with one or more validation rules, such as a predetermined activation interval, a preauthorized fuel exchange amount, an indication that the fuel code is a single-use fuel-code or a predetermined proximity value respective to a fueling location. In some embodiments, the remote server 200 stores, in association with the fuel code 406A, data identifying a fuel exchange discount, such as a discrete value of or percentage-based reduction to a fuel exchange ratio by which a fuel amount may be generated. To implement certain of these validation rules, such as implementing the requirement that fuel codes are single-use fuel codes, the remote server 200 may (either periodically, or upon detecting a trigger event, such as an attempted redemption of a fuel code) compare one or more outstanding, unredeemed fuel codes against a list of redeemed fuel codes. For those fuel codes that have been redeemed, data stored in association with those fuel codes may be updated to indicate that the code has been redeemed.

Each fuel code may be unique, such that no two fuel codes are identical. In practice, fuel codes may periodically be recycled, such as after all fuel codes of a designated length of numeric or alphanumeric characters have been generated. In such embodiments, data reflecting all redeemed fuel codes may be archived for later access or deleted entirely, such that the remote server can recycle the used fuel codes without changing the operations discussed herein.

In some embodiments, the remote server 200 provides a copy of the fuel code, fuel code 406B, to the user computing entity 111 (see indicium 2). The user computing entity 111 may store the fuel code 406B in memory. The user computing entity 111 may generate and render on a display a fuel code interface 403 that includes the fuel code 406B.

In some embodiments, the fuel exchange system 103 receives a user input 405 or other input indicative of the fuel code 406 (see indicium 3). For example, a user entity may present the fuel code interface 403 to an operator of a fuel exchange system 103. The operator may provide the fuel code 406B rendered thereon to the fuel exchange system 103 by providing the user input 405 to a fuel exchange software interface, such as a graphical user interface rendered on a display of the fuel exchange system 103 or a separate computing device in communication with the fuel exchange system 103.

In some embodiments, the software of the fuel exchange system 103 is not specifically configured to recognize a user input as a fuel code. In such embodiments, the fuel code 406B may be provided within a user input field of a graphical user interface (GUI) originally designed to accept payment details. For example, the fuel code 406B may be provided within a user input field of a fuel exchange software interface 800 shown in FIG. 8 and described herein, which may be a legacy or existing user input field traditionally utilized for manually inputting a payment card number. The fuel code 406B may be provided in a format that will be accepted, at least temporarily, by the locally executable software on the fuel exchange system 103. The fuel code 406B may be stored in memory that is accessible by external software systems so that the complete transaction data can be intercepted before it is transmitted as a traditional fuel exchange transaction (e.g., which would result in the denial/rejection of the transaction/fuel code as an improper payment method) and can be redirected to the system components discussed herein for processing a transaction using the fuel code 406B. In some embodiments, to avoid the need for additional cashier and/or other user entity training, a graphical user interface on the user computing entity 111 of the user entity that presents the fuel code 406B may explicitly describe the fuel code as a “payment number,” a “credit card,” a “payment card,” and/or the like, to suggest to the user that the fuel code should be provided in the payment information field of the GUI of the fuel exchange system 103.

Alternatively, the fuel exchange system 103 receives the fuel code 406B via an image capture system configured to generate a capture of the fuel code interface 403, from which the fuel code 406B may be extracted or generated at the fuel exchange system 103. In another alternate embodiment, the fuel exchange system 103 receives the fuel code 406B via a device that wirelessly reads or receives the fuel code 406B from a wireless communication element of the user computing entity 111. Where the user computing entity 111 is configured to provide the fuel code directly to the fuel exchange system 103 (without user input provided to the fuel exchange system 103), the user computing entity 111 may be configured to store the fuel code in multiple formats thereon. A first format may be a human-readable format to be displayed as a part of a graphical user interface, and a second format may be a machine-readable format that can be provided to the fuel exchange system 103 (e.g., a barcode, QR code, or other format that can be wirelessly communicated/read from the user computing entity 111 to the fuel exchange system 103. The fuel exchange system 103 may temporarily store the user input 405 (and/or other input) in memory according to a storage instruction, such as a third-party storage instruction installed at the fuel exchange system 103. The storage instruction, when installed and executed, may cause the fuel exchange system 103 to determine whether a user input is of a particular format associated with fuel codes (e.g., subsequent operations of the data flow 400 occurring in response to positive determination that the user input 405 is of the particular format).

In some embodiments, the fuel exchange system 103 generates a fuel exchange authorization data object 407 based on the user input 405 and provides the fuel exchange authorization data object 407 to a fuel exchange processing service 105 (see indicium 4). The fuel exchange system 103 may provide the fuel exchange authorization data object 407 to the fuel exchange processing service 105 using an application programming interface (API) configured to enable network-based communication between the fuel exchange system 103 and the fuel exchange processing service 105. The fuel exchange authorization data object 407 may include the fuel code 406B and potentially other data, such as a receipt timestamp of the user input 405 or an identifier for a fuel entity associated with the fuel exchange system 103.

In some embodiments, the fuel exchange authorization data object 407 includes a fuel volume provided to a user entity. For example, the fuel exchange authorization data object 407 may include a number of gallons of fuel dispensed by a fueling system. In some embodiments, the fuel exchange authorization data object 407 includes a timestamp corresponding to activation of a fueling system and/or a timestamp corresponding to completion of fueling via the fueling system. For example, the fuel exchange authorization data object 407 may include a timestamp at which a fuel pump was activated in response to a user entity's manipulation of a fuel pump handle and/or selection of a fuel type via a graphical user interface at the fuel pump. The fuel exchange authorization data object 407 may include a timestamp at which the fuel pump handle was reinserted into the fuel pump. In another example, the fuel exchange authorization data object 407 includes a timestamp at which the fuel exchange system 103 provided a fueling start code to a fueling system and/or a timestamp at which the fuel exchange system 103 provided a fueling end code to the fueling system. In some embodiments, the fuel exchange authorization data object 407 includes an identifier for the fueling system. For example, the fuel exchange authorization data object 407 may include a fuel pump number and/or the like.

In some embodiments, the fuel exchange authorization data object 407 includes data defining a location at which the user input 405 was received and/or a fueling system associated with the fuel exchange is located. For example, the fuel exchange authorization data object 407 may include a physical address of a fueling station. In some embodiments, the fuel exchange authorization data object 407 includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange authorization data object 407 indicates whether the fuel exchange is authorized or in-process. For example, the fuel exchange authorization data object 407 may indicate that a fuel exchange has not been approved by a payment instrument administrator. In another example, the fuel exchange authorization data object 407 may indicate that the fuel exchange is preauthorized and may include a preauthorization limit. In some embodiments, the fuel exchange authorization data object 407 includes one or more product identifiers, such as a stock keeping unit (SKU), part number, product number, universal product code (UPC), standard case code (SCC) and/or the like. In one example, the fuel exchange authorization data object 407 includes an identifier for a type of fuel provided (or requested to be provided) for the fuel exchange, a first SKU for a fuel additive product, and a third SKU for an anti-freeze product.

In some embodiments, the fuel exchange system 103 generates the fuel exchange authorization data object 407 via existing (e.g., native or manufacturer-installed) point of sale software that outputs the fuel exchange authorization data object 407 in a data format usable by the fuel exchange system 103 according to existing software. For example, the fuel exchange system 103 may generate the fuel exchange authorization data object 407 in a format that corresponds to a format for fuel exchange initiated in response to receipt of traditional payment instrument data. In some embodiments, the fuel exchange system 103 stores the fuel exchange authorization data object 407 in memory such that the fuel exchange authorization data object 407 is accessible by other software programs. For example, the fuel exchange system 103 may store the fuel exchange authorization data object 407 in a tabular format, a graphical database format, and/or the like, such that the fuel exchange authorization data object 407 may be accessed by a script that recognizes the fuel exchange authorization data object 407 and/or fuel code 306B indicated by the fuel exchange authorization data object 407.

In some embodiments, the script automatically retrieves the fuel exchange authorization data object 407 and converts the fuel exchange authorization data object 407 into a data format that may be provided to or extracted by the fuel exchange processing service 105. In some embodiments, the script reformats the fuel exchange authorization data object 407 by concatenating one or more characters, truncating one or more characters, replacing one or more characters of, and/or adding one or more characters to, the fuel exchange authorization data object 407. In some embodiments, the script reformats all fuel transaction authorization data objects in an identical manner. In alternate embodiments, the script reformats each fuel transaction authorization data object in a manner unique to each fuel code. In some embodiments, the script generates a format by which to reformat the fuel exchange authorization data object 407 based on the fuel code 306B.

In some embodiments, the fuel exchange system 103 temporarily stores the fuel exchange authorization data object 407 for a period sufficient to allow the script to reformat the fuel exchange authorization data object 407 and provide the fuel exchange authorization data object 407 to the fuel exchange processing service 105. In some embodiments, following the period and/or providing of the fuel exchange authorization data object 407 to the fuel exchange processing service 105, the fuel exchange system 103 deletes the format-modified fuel exchange authorization data object 407 from memory such that the modified data does not interfere with existing operations of the original software (e.g., native point of sale software) running on the fuel exchange system 103. In one example, temporary storage and subsequent deletion of the differently formatted fuel exchange authorization data object 407 may prevent interference with native point of sale software that requires transaction data to be stored in an original data format. In some embodiments, the fuel exchange system 103 retains, in memory, the fuel exchange authorization data object 407 in an unmodified format.

In some embodiments, the fuel exchange system 103 updates the original fuel exchange authorization data object 407 in response to approval or other outcome for the fuel exchange (e.g., partial approval, denial, and/or the like). In some embodiments, the above-described script performs the update by communicating with an exchange processing service that processes a payment transaction for fuel exchange (e.g., the fuel exchange processing service 105 or another external computing system). In alternate embodiments, the fuel exchange system 103 receives direct communication from the exchange processing service such that the approval of other outcome for the fuel exchange resembles a traditional transaction outcome, which may allow the fuel exchange system 103 to update the unmodified fuel exchange authorization data object 407 in the original format. In some embodiments, following updating by the fuel exchange system 103, the script retrieves the fuel exchange authorization data object 407 and reformats the fuel exchange authorization data object 407. In some embodiments, the script causes the temporary storage and subsequent deletion of the reformatted fuel exchange authorization data object 407 in memory after the script provides the reformatted fuel exchange authorization data object 407 to the fuel exchange processing service 105, which may relay the reformatted fuel exchange authorization data object 407 to the remote server 200 (e.g., for recordation of the fuel exchange outcome).

In some embodiments, the fuel exchange processing service 105 provides the fuel exchange authorization data object 407 to the remote server 200 (see indicium 5). The fuel exchange processing service 105 may provide the fuel exchange authorization data object 407 to the remote server 200 using a second application programming interface (API) configured to enable network-based communication between the fuel exchange processing service 105 and the remote server 200.

In some embodiments, the remote server 200 obtains the fuel code 406B from the fuel exchange authorization data object 407 and compares the fuel code 406B to one or more fuel codes stored at the data store 102, including the fuel code 406A. The remote server 200 may query the data store 102 based on the fuel code 406B and, in response, receive a result including a match between the fuel code 406A and fuel code 406B. Additionally, or alternatively, the remote server 200 may query the data store 102 based on the identifier for the fuel entity (e.g., when indicated by the fuel exchange authorization data object 407). Additionally, in some embodiments, the remote server 200 may compare the identifier for the fuel entity indicated by the fuel exchange authorization data object to the entity identifier stored in association with the fuel code 406A at the data store 102. The remote server 200 may determine whether the indicated identifier matches the stored entity identifier, where a positive determination may confirm a threshold for validating the fuel code 406B. Additionally, or alternatively, in some embodiments, the remote server 200 may determine whether a receipt timestamp of the user input 405 is within a predetermined activation interval (e.g., 1 hour, 12 hours, 1 day, or any suitable interval measured from a receipt time of the fuel code request 401), where a positive determination may confirm a threshold for validating the fuel code 406B. Additionally, or alternatively, in some embodiments, the remote server 200 may determine a location of the user computing entity 111, such as by requesting and receiving geolocation data from the user computing entity 111. The remote server 200 may determine whether the location of the user computing entity 111 is within a predetermined proximity of a fueling location associated with the indicated identifier for the fuel entity, where a positive determination may confirm a threshold for validating the fuel code 406B.

In some embodiments, the remote server 200 generates and provides to the fuel exchange processing service 105 a fuel code validation 409 (see indicium 7). The remote server 200 may provide the fuel code validation 409 to the fuel exchange processing service using the second API as described above. The fuel code validation 409 may indicate to the fuel exchange processing service 105 and fuel exchange system 103 authorization to initiate a fuel event respective to a user entity associated with the user computing entity 111. The fuel code validation 409 may include or indicate additional data, such as a fuel exchange ratio, maximum fuel volume, and/or preauthorized fuel exchange amount.

In some embodiments, the fuel exchange processing service 105 provides the fuel code validation 409 to the fuel exchange system 103 (see indicium 8). The fuel exchange processing service 105 may provide the fuel code validation 409 to the fuel exchange system 103 using the first API as described above. In response to receiving the fuel code validation 409, the fuel exchange system 103 may initiate a fuel event. For example, the fuel exchange system 103 may transition a fueling system from an inactive state to an active state such that fuel may be dispensed from the fueling system. In another example, the fuel exchange system 103, or an operator thereof, may allow a user entity to obtain a fuel container from a storage receptacle or confer ownership of an amount of fuel to the user entity.

In some embodiments, the fuel exchange system 103 transmits a fueling start signal to the fueling system, which causes the fueling system to transition from an inactive state to an active state in which fuel may be obtained by a user entity. In some embodiments, the fuel exchange system 103 provides additional data to the fueling system including a fuel type, a maximum fuel volume, and/or a maximum fuel exchange amount (e.g., which may be based on a preauthorization limit and/or the like). In some embodiments, the activation of the fueling system enables the fueling system to access fuel from a fuel reservoir. For example, the transition to the active state may cause opening of a valve such that fuel may be dispensed from the fueling system. In some embodiments, the activation of the fueling system causes the fueling system to initiate a fuel volume counter, fuel discharge rate monitor, or other device or software program that measures a volume of fuel provided by the fueling system. In some embodiments, the fueling system generates a start timestamp indicative of a start time of receiving the fuel start code or dispensing of fuel from the fuel system. In some embodiments, the fueling system determines that a fuel event has ended. For example, the fueling system determines that a fuel pump handle has been reinserted into a fuel pump for a predetermined time period and, in response, determines that fueling has ended. In some embodiments, the fueling system automatically terminates fueling (e.g., by transitioning to the inactive state) in response to determining that a particular volume of fuel has been provided to a user entity, that a value of fuel provided to the user entity meets a threshold fuel exchange amount, or that a container for receiving fuel has reached a maximum fill level. In some embodiments, the fueling system terminates fueling in response to receiving a fuel end code or other signal from the fuel exchange system 103.

In some embodiments, in response to termination of fueling, the fueling system generates a total fuel volume for the amount of fuel provided to the user entity and/or a fuel exchange amount based on the total fuel volume and a fuel exchange ratio. In some embodiments, the fuel exchange system 103 performs functions for monitoring a fuel event and generating data associated therewith. In some embodiments, the fueling system provides to the fuel exchange system 103 data related to the fuel event including a start timestamp, end timestamp, total fuel volume, fuel exchange amount, and/or other output of a fuel counter. In some embodiments, the fuel exchange system 103 updates the original-formatted fuel exchange authorization data object 407 based on the fuel event data. In some embodiments, following updating by the fuel exchange system 103, the script retrieves the fuel exchange authorization data object 407 and reformats the fuel exchange authorization data object 407. In some embodiments, the script causes the temporary storage and subsequent deletion of the reformatted fuel exchange authorization data object 407 in memory after the script provides the reformatted fuel exchange authorization data object 407 to the fuel exchange processing service 105, which may relay the reformatted fuel exchange authorization data object 407 to the remote server 200 (e.g., for recordation of the fuel event data and further processing of the fuel exchange). In some embodiments, a fuel exchange payload is generated based on the fuel event data and/or updated fuel exchange authorization data object 407.

In some embodiments, the fuel exchange system 103 generates and provides to the fuel exchange processing service a fuel exchange payload 411 (see indicium 9). The fuel exchange system 103 may provide the fuel exchange payload 411 to the fuel exchange processing service using the first API described above. The fuel exchange payload 411 may indicate or include a fuel exchange amount. In some embodiments, the fuel exchange system generates the fuel exchange amount based on the fuel volume and a fuel exchange ratio. The fuel exchange ratio may be an unmodified fuel exchange ratio or a fuel exchange ratio modified by a discount, which may be received by the fuel exchange system 103 from the remote computing environment via the fuel exchange processing service 105 and one or more APIs 140.

In some embodiments, the fuel exchange payload 411 includes a fuel volume provided to a user entity. For example, the fuel exchange payload 411 may include a number of gallons of fuel dispensed by the fueling system during the fuel event. In some embodiments, the fuel exchange payload 411 includes a timestamp corresponding to activation of the fueling system and/or a timestamp corresponding to completion of fueling via the fueling system. For example, the fuel exchange payload 411 may include a timestamp at which a fuel pump was activated in response to a user entity's manipulation of a fuel pump handle and/or selection of a fuel type via a graphical user interface at the fuel pump. The fuel exchange payload 411 may include a timestamp at which the fuel pump handle was reinserted into the fuel pump. In another example, the fuel exchange payload 411 includes a timestamp at which the fuel exchange system 103 provided a fueling start code to a fueling system and/or a timestamp at which the fuel exchange system 103 provided a fueling end code to the fueling system. In some embodiments, the fuel exchange payload 411 includes an identifier for the fueling system. For example, the fuel exchange payload 411 may include a fuel pump number and/or the like.

In some embodiments, the fuel exchange payload 411 includes data defining a location at which the user input 405 was received and/or a fueling system associated with the fuel exchange is located. For example, the fuel exchange payload 411 may include a physical address of a fueling station. In some embodiments, the fuel exchange payload 411 includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange payload 411 indicates whether the fuel exchange is authorized or in-process. For example, the fuel exchange payload 411 may indicate that a fuel exchange has not been approved by a payment instrument administrator. In another example, the fuel exchange payload 411 may indicate that the fuel exchange is preauthorized and may include a preauthorization limit. In some embodiments, the fuel exchange payload 411 includes one or more product identifiers, such as a stock keeping unit (SKU), part number, product number, universal product code (UPC), standard case code (SCC) and/or the like.

In some embodiments, the fuel exchange system 103 generates the fuel exchange payload 411 via existing (e.g., native or manufacturer-installed) point of sale software that outputs the fuel exchange payload 411 in a data format usable by the fuel exchange system 103 according to existing software. For example, the fuel exchange system 103 may generate the fuel exchange payload 411 in a format that corresponds to a format for fuel exchange initiated in response to receipt of traditional payment instrument data. In some embodiments, the fuel exchange system 103 stores the fuel exchange payload 411 in memory such that the fuel exchange payload 411 is accessible by other software programs. For example, the fuel exchange system 103 may store the fuel exchange payload 411 in a tabular format, a graphical database format, and/or the like, such that the fuel exchange payload 411 may be accessed by a script that recognizes the fuel exchange payload 411 and/or fuel code 306B indicated by the fuel exchange payload 411.

In some embodiments, the script automatically retrieves the fuel exchange payload 411 and converts the fuel exchange payload 411 into a data format that may be provided to or extracted by the fuel exchange processing service 105. In some embodiments, the script reformats the fuel exchange payload 411 by concatenating one or more characters, truncating one or more characters, replacing one or more characters of, and/or adding one or more characters to, the fuel exchange payload 411. In some embodiments, the script reformats all fuel exchange payloads in an identical manner. In alternate embodiments, the script reformats each fuel exchange payload in a manner unique to each fuel code. In some embodiments, the script generates a format by which to reformat the fuel exchange payload 411 based on the fuel code 306B.

In some embodiments, the fuel exchange system 103 temporarily stores the fuel exchange payload 411 for a period sufficient to allow the script to reformat the fuel exchange payload 411 and provide the fuel exchange payload 411 to the fuel exchange processing service 105. In some embodiments, following the period and/or providing of the fuel exchange payload 411 to the fuel exchange processing service 105, the fuel exchange system 103 deletes the format-modified fuel exchange payload 411 from memory such that the modified data does not interfere with existing operations of the original software (e.g., native point of sale software) running on the fuel exchange system 103. In one example, temporary storage and subsequent deletion of the differently formatted fuel exchange payload 411 may prevent interference with native point of sale software that requires transaction data to be stored in an original data format. In some embodiments, the fuel exchange system 103 retains, in memory, the fuel exchange payload 411 in an unmodified format.

In some embodiments, the fuel exchange system 103 updates the original fuel exchange payload 411 in response to approval or other outcome for the fuel exchange (e.g., partial approval, denial, and/or the like). In some embodiments, the above-described script performs the update by communicating with an exchange processing service that processes a payment transaction for fuel exchange (e.g., the fuel exchange processing service 105 or another external computing system). In alternate embodiments, the fuel exchange system 103 receives direct communication from the exchange processing service such that the approval of other outcome for the fuel exchange resembles a traditional transaction outcome, which may allow the fuel exchange system 103 to update the unmodified fuel exchange payload 411 in the original format. In some embodiments, following updating by the fuel exchange system 103, the script retrieves the fuel exchange payload 411 and reformats the fuel exchange payload 411. In some embodiments, the script causes the temporary storage and subsequent deletion of the reformatted fuel exchange payload 411 in memory after the script provides the reformatted fuel exchange payload 411 to the fuel exchange processing service 105, which may relay the reformatted fuel exchange payload 411 to the remote server 200 (e.g., for recordation of the fuel exchange outcome).

In some embodiments, the fuel exchange processing service 105 provides the fuel exchange payload 411 to the remote server 200 (see indicium 10). The fuel exchange processing service 105 may provide the fuel exchange payload 411 to the remote server 200 using the second API as described above. The fuel exchange processing service 105 may modify the fuel exchange payload 411 to include a service amount (e.g., a fee for processing fuel exchange-related data). In some embodiments, the fuel exchange processing service 105 executes a script that reformats the fuel exchange payload 411 to indicate a service amount by concatenating one or more characters, truncating one or more characters, replacing one or more characters of, and/or adding one or more characters to, the fuel exchange payload 411. In some embodiments, the fuel exchange processing service provides modified fuel exchange payload 411 to the fuel exchange system 103. In some embodiments, the fuel exchange system 103 temporarily stores the modified fuel exchange payload 411 for a period sufficient to allow a script executed by the fuel exchange system 103, or a storage computing system in communication therewith, to reformat the modified fuel exchange payload 411 into an original format. In some embodiments, following reformatting, the fuel exchange system 103 deletes the modified fuel exchange payload 411 and stores the original-formatted fuel exchange payload 411 in memory (e.g., or updates the original formatted fuel exchange authorization data object 407 based thereon and stores the updated fuel exchange authorization data object). Deletion of the format-modified fuel exchange payload 411 from memory and/or storage of the reformatted fuel exchange payload 411 may prevent interference with existing operations of the original software (e.g., native point of sale software) running on the fuel exchange system 103. In one example, temporary storage and subsequent deletion of the differently formatted fuel exchange payload 411 may prevent interference with native point of sale software that requires transaction data to be stored in an original data format. In some embodiments, as described in reference to the preceding indicia, the fuel exchange-related data generated and/or received by the original software of the fuel exchange system 103 is reformatted twice by different computing systems and/or scripts before being provided to the remote server 200. For example, a fuel exchange payload 411 and/or fuel exchange authorization data object 407 may be reformatted by a first script at the fuel exchange system 103 and/or a storage computing device. The fuel exchange payload 411 and/or fuel exchange authorization data object 407 may be reformatted a second time by a second script at the fuel exchange processing service 105 before being provided to the remote server 200.

In some embodiments, the remote server 200 processes an exchange of value for the fuel exchange using the fuel exchange payload 411 and data associated with a user entity's instrument of exchange (e.g., credit card, debit card, banking account, cryptographic asset wallet, etc.), which may be stored at the data store 102 in a user account and retrieved in response to the fuel code validation 409. The remote server 200 may communicate with an administrator or issuer of the instrument of exchange to process an exchange of value in an amount corresponding to the fuel exchange amount (e.g., potentially including additional amounts such as a service amount for the fuel exchange processing service 105 and/or a surcharge amount for the operator of the remote server 200).

In some embodiments, the remote server 200 generates an updated fuel exchange payload based on the fuel exchange payload 411. For example, the remote server 200 generates an updated fuel exchange amount based on an undiscounted fuel exchange amount indicated in the fuel exchange payload 411 and a discounted fuel exchange ratio generated by the remote server 200 when the fuel code 406A was generated (e.g., the discounted fuel exchange ratio being stored in association with the fuel code 406A). In another example, the remote server 200 generates an updated fuel exchange amount based on an undiscounted fuel exchange ratio determined and stored at the time of generation of the fuel code 406A.

In some embodiments, the remote server 200 generates the updated fuel exchange amount based on a retail price of the fuel, which may be indicated by the fuel exchange payload 411 and/or determined and stored at the time of generation of the fuel code 406A. For example, the remote server 200 may determine an undiscounted retail price (e.g., fuel exchange ratio) of the fuel to be $5.00 per unit volume of fuel. The remote server 200 may apply a predetermined discount value to the undiscounted retail price to generate a discounted fuel exchange ratio of $4.50 per unit volume of fuel. The remote server 200 may generate a fuel exchange amount based on the discounted fuel exchange ratio and a fuel volume indicated in the fuel exchange payload 411.

In some embodiments, the remote server 200 generates the updated fuel exchange amount based on a wholesale exchange amount or ratio of the fuel, which may be indicated by the fuel exchange payload 411 and/or determined and stored at the time of generation of the fuel code 406A. For example, the remote server 200 may determine a wholesale price (e.g., fuel exchange ratio) of the fuel to be $2.50 per unit volume of fuel. The remote server 200 may apply a predetermined scaling value to the wholesale price to generate a scaled fuel exchange ratio of $3.00 per unit volume of fuel. The remote server 200 may generate a fuel exchange amount based on the scaled fuel exchange ratio and a fuel volume indicated in the fuel exchange payload 411. In some embodiments, the remote server 200 further modifies the fuel exchange amount to include a service fee.

In some embodiments, to request approval of the fuel exchange amount, the remote server 200 generates and transmits a transaction processing request to a transaction processing server. In some embodiments, the transaction processing request includes the fuel exchange amount and authorization data for the user entity's instrument of exchange, such as a credit card number, expiration date, card verification value, and/or the like, and additional information from the fuel exchange payload 411 and/or fuel exchange authorization data object 407 described herein. In some embodiments, the remote server 200 provides the fuel exchange payload 411 to the transaction processing server using the fuel exchange processing service 105 and/or one or more APIs 140. In some embodiments, the remote server 200 receives an outcome of the fuel exchange from the transaction processing server via a network 150 and using one or more APIs 140. The transaction processing entity may communicate with a financial institution, such as a bank, or other administrator of a user entity's instrument of exchange to obtain authorization for and process an exchange of value for the fuel exchange amount.

In some embodiments, the remote server 200 generates and provides to the fuel exchange processing service 105 and/or user computing entity 111 a fuel exchange outcome 413 (see indicia 11 and 13). The remote server 200 may provide the fuel exchange outcome 413 to the fuel exchange processing service 105 using the second API as described above. The fuel exchange outcome 413 may indicate whether the exchange of value in the fuel exchange amount was approved, partially approved, or denied. In some embodiments, if partially approved or denied, the fuel exchange outcome 413 may indicate one or more reasons, such as insufficient funds, preauthorization limit, suspected fraud, and/or the like.

In some embodiments, the fuel exchange processing service 105 provides the fuel exchange outcome 413 to the fuel exchange system 103 (see indicium 12). The fuel exchange processing service 105 may provide the fuel exchange outcome 413 to the fuel exchange system 103 using the first API as described above. In some embodiments, the fuel exchange processing service 105 or the fuel exchange system 103 (or a storage computing system in communication therewith) executes a script that reformats the fuel exchange outcome 413 to an original format of point-of-sale software at the fuel exchange system 103, such as by splitting one or more characters, concatenating one or more characters, truncating one or more characters, replacing one or more characters of, and/or adding one or more characters to, the fuel exchange outcome 413.

In some embodiments, the fuel exchange processing service 105 provides the fuel exchange outcome 413 to the fuel exchange system 103. In some embodiments, the fuel exchange system 103 temporarily stores the fuel exchange outcome 413 for a period sufficient to allow a script executed by the fuel exchange system 103, or a storage computing system in communication therewith, to reformat the modified fuel exchange outcome 413 into an original format. In some embodiments, following reformatting, the fuel exchange system 103 deletes the received fuel exchange outcome 413 and stores the original-formatted fuel exchange outcome 413 in memory (e.g., or updates the original formatted fuel exchange authorization data object 407 or fuel exchange payload 411 based thereon and stores the updated fuel exchange authorization data object). Deletion of the received fuel exchange outcome 413 from memory and/or storage of the reformatted fuel exchange outcome 413 may prevent interference with existing operations of the original software (e.g., native point of sale software) running on the fuel exchange system 103. In one example, temporary storage and subsequent deletion of the differently formatted fuel exchange outcome 413 may prevent interference with native point of sale software that requires transaction outcomes to be stored in an original data format. In some embodiments, as described in reference to the preceding indicia, the fuel exchange outcome 413 received by the remote server 200 is reformatted twice by different computing systems and/or scripts before being stored at the fuel exchange system 103. For example, a fuel exchange outcome 413 may be reformatted by a first script at the remote server 200. The fuel exchange outcome 413 may be reformatted a second time by a second script at the fuel exchange processing service 105 before being provided to the fuel exchange system 103. Such reformatting processes throughout the data flow 400 may enable backwards compatibility of the present systems and methods with existing fuel exchange systems that demonstrate highly variant software and hardware configurations.

In some embodiments, the fuel exchange outcome 413 causes the fuel exchange system 103 to activate a fueling system, such as in instances where the fuel exchange payload 411 is generated and processed prior to a fuel event. For example, the remote server 200 remotely activates a fueling system by transmitting the fuel exchange outcome 413 to the fuel exchange system 103 using the fuel exchange processing service 105 and one or more APIs 140, effectively using the fuel exchange system 103 as a tool or interface for remotely initiating fuel events on behalf of a user entity and in a manner such that the user entity may recognize a reduced cost of obtaining fuel.

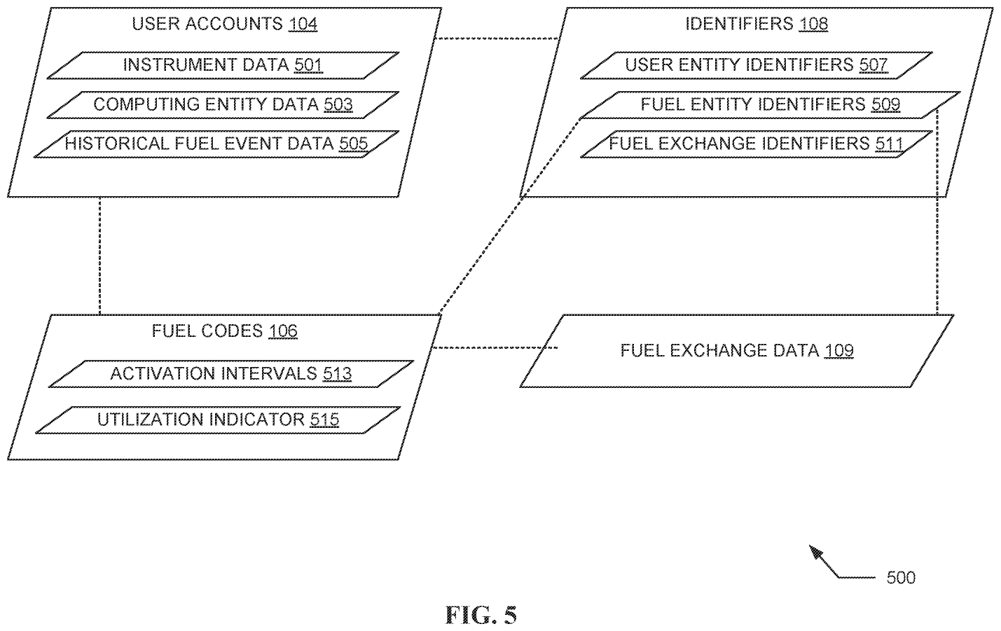

FIG. 5 provides an example data architecture according to certain embodiments. In some embodiments, the user account 104 includes instrument data 501 that identifies a user entity's instrument of exchange and data necessary for processing exchanges of value using the instrument of exchange. In some embodiments, the instrument data 501 includes an instrument identifier (e.g., card number, account number, wallet address, and/or the like), an instrument expiration date, a billing address, a user entity's legal name, an instrument verification (e.g., card verification value and/or the like), a preauthorization limit, a maximum fuel volume, and/or the like. In some embodiments, the user account 104 includes computing entity data 503 that identifies and/or enables communication with a user entity's user computing entity 111. In some embodiments, the computing entity data 503 includes a phone number, internet protocol (IP) address, media access control (MAC) address, international mobile equipment identifier (IMEI) number, and/or the like. In some embodiments, the user account 104 includes historical fuel event data 505 that defines historical fuel events and fuel exchanges associated with the user entity. In some embodiments, the historical fuel event data 505 includes historical fuel exchange amounts, historical fuel volumes, historical fuel locations, historical product codes, historical discounts or savings amounts generated by the remote computing environment 101 or application 122 based thereon, and/or the like. In some embodiments, the user account 104 includes associations between the user account 104 and one or more fuel codes 106. In some embodiments, the user account 104 includes associations between the user account 104 and one or more identifiers 108, such as a user entity identifier 507, one or more fuel entity identifiers 509, and/or one or more fuel exchange identifiers 511.

In some embodiments, the fuel codes 106 include active fuel codes that have not been utilized in a fuel exchange. In some embodiments, the fuel codes 106 include inactive fuel codes that have been previously utilized in a fuel exchange or are no longer able to be used based on expiration of an activation interval and/or other validation policy. In some embodiments, the fuel codes 106 include one or more activation intervals 513 that define a predetermined time interval within which a fuel code 106 may be used in a fuel exchange and after which a fuel code 106 may be rendered unusable for use in a fuel exchange. In some embodiments, the fuel codes 106 include utilization indicators 515 that indicate whether a fuel code 106 has been used in a fuel exchange and/or rendered unusable for use in a fuel exchange based on previous usage or a validation policy, such as expiration of an activation interval 513. In some embodiments, the fuel codes 106 include associations between one or more fuel codes 106 and a user account 104, a fuel entity identifier 509, a fueling location 517, a user entity identifier 507, and/or the like.

In some embodiments, the identifiers 108 include user entity identifiers 507 that indicate a particular user entity and/or user computing entity 111. In some embodiments, the identifiers 108 include fuel entity identifiers 509 that indicate a particular fuel entity, such as a fueling station or operator thereof. In some embodiments, the identifiers 108 include fuel exchange identifiers 511 that identify a current or historical fuel exchange (e.g., including data associated therewith, such as fuel event data, fuel exchange authorization data objects, fuel exchange payloads, fuel exchange outcomes, and/or the like). In some embodiments, the fuel exchange data 109 includes any data related to a current or historical fuel exchange. For example, the fuel exchange data 109 may include a fuel exchange amount, unmodified fuel exchange ratio (e.g., retail fuel exchange ratio, wholesale fuel exchange ratio, etc.), modified fuel exchange ratio, fuel volume, fueling start time, fueling end time, fueling system identifier, fueling location identifiers, associations between fuel exchange data and a fuel code 106, user account 104, and/or one or more identifiers 108, and/or the like.

FIG. 6 provides an example flowchart of an example process 600 for authorizing a fuel exchange according to certain embodiments. In some embodiments, prior to step/operation 603, the process 600 includes installing one or more storage instructions at a fuel exchange system, fuel exchange processing service, and/or remote server, where the storage instruction may define an executable script for recognizing, reformatting, and/or temporarily storing and subsequently deleting particular data. For example, the fuel exchange system 103 may receive and install a storage instruction that defines a script. The script, when executed by the fuel exchange system, may cause the fuel exchange system to recognize that a user input indicates a fuel code. The script may further enable the fuel exchange system to reformat fuel codes, fuel exchange authorization data objects, fuel exchange payloads, and/or fuel exchange outcomes between an original format and a modified format, where the modified format may configure the data for receipt by a fuel exchange processing service and/or remote server.

In some embodiments, the script configures the fuel exchange system to temporarily stores data a period sufficient to allow the script to reformat the data and provide the reformatted data to a fuel exchange processing service or remote server (e.g., the reformatted data being deleted thereafter, and the original formatted data retained). In some embodiments, the script configures the fuel exchange system to, following a predetermined period and/or providing of the data to the fuel exchange processing service or the remote server, delete the reformatted data from memory such that the modified data does not interfere with existing operations of the original software (e.g., native point of sale software) running on the fuel exchange system. In one example, temporary storage and subsequent deletion of the differently formatted data may prevent interference with native point of sale software that requires transaction data to be stored in an original data format. In some embodiments, the script configures the fuel exchange system to retain the original data in an unmodified format.

In some embodiments, prior to step/operation 603, the process 600 includes receiving a request to generate a fuel code from a user computing entity and, in response to the request, generating the fuel code, storing the fuel code, and providing the fuel code to the user computing entity. For example, the remote server 200 may receive from a user computing entity 111 a request to generate a fuel code 106. The remote server 200 may authenticate the request based on determining whether the user computing entity 111 is associated with a user account 104. In some embodiments, prior to receiving the request, the remote server 200 performs a registration process to enroll a user entity, the user entity's user computing entity 111, and the user entity's instrument of exchange, which may include generating a user account 104 and storing data indicative of the instrument of exchange in association with the user account 104. In some embodiments, in response to the request, the remote server 200 generates a fuel code 106. In some embodiments, the request indicates one or more products for a fuel exchange, such as via a product name, product code, and/or the like. Non-limiting examples of the products include fuel additives, fuel types, vehicle parts, vehicle fluids (e.g., brake fluid, transmission fluid, anti-freeze), maintenance services, and/or the like. The remote server 200 may store the indicated products in association with the fuel code 106 generated in response to the request. In various embodiment, the fuel code 106 may be used to initiate exchanges of value for multiple products, even in instances where a fuel exchange system does not differentiate between products when processing and transmitting fuel exchange-related data.

The remote server 200 may store the fuel code 106 at the data store 102 in association with an identifier for the user computing entity 111, an identifier for the user account 104, and/or an identifier associated with a fuel entity, which may be indicated in the request to generate to generate the fuel code. The remote server 200 may provide the fuel code to the user computing entity 111 via a network 150.

At step/operation 603, the process 600 includes receiving a user input indicative of the fuel code. In some embodiments, receiving the user input includes a user entity presenting a display of a user computing entity to an operator of a fuel exchange system, where the display includes a rendering of the fuel code. For example, an application 122 installed on or accessed by a user computing entity 111 may render a fuel code 106 on a display 118. A user entity may present the display 118, including the fuel code 106, to an operator of a fuel exchange system 103. In some embodiments, receiving the user input includes the fuel exchange system receiving one or more inputs to an input device. For example, the fuel exchange system 103 may receive the user input indicative of the fuel code 106 via one or more inputs to an input device 110, such as a fuel exchange software interface.

In some embodiments, the fuel exchange system receives an input indicative of a fuel code via wireless communication with a user computing entity. For example, a fuel exchange system 103 may include a scanning device, such as a near field communication circuitry, Bluetooth antennae, and/or the like, configured to wirelessly communicate with a user computing entity 111 (e.g., or application 122 associated therewith) to obtain a fuel code 106. In a particular example, the user computing entity 111 may be a mobile telecommunication device and the fuel exchange system 103 may be configured to receive a wireless transmission including a fuel code 106 from the mobile telecommunication device. In another example, the user computing entity 111 may include a programmable radio frequency identification (RFID) circuit to which a fuel code 106 by the application 122. An input device 110 of the fuel exchange system 103 may include an RFID reader circuit configured to detect and read the fuel code 106 from the RFID circuit.

Alternatively, or additionally, in some embodiments, the fuel exchange system receives an input indicative of a fuel code by generating and processing a capture of scannable media (e.g., a linear bar code, QR code, or other matrix code, and/or the like) to extract or generate the fuel code. In one example, an application 122 on a user computing entity 111 may generate and render on the display 118 a QR code that encodes a fuel code 106. An input device 110 of the fuel exchange system 103 may include an image capture device or other scanning device that generates a capture of the QR code. The fuel exchange system 103 may process the capture of the QR code to extract or generate the fuel code 106. In another example, an application 122 may generate and render on the display 118 a QR code that includes a network address at which a fuel code 106 may be accessed or retrieved. The fuel exchange system 103 may extract or generate the network address based on a capture of the QR code and obtain the fuel code 106 by accessing the network address and/or providing a request to the network address.

Alternatively, or additionally, in some embodiments, the fuel exchange system receives an input indicative of a fuel code by receiving and processing a vocal input. For example, the input device 110 of the fuel exchange system 103 may include a microphone configured to capture utterance of a fuel code 106. The fuel exchange system 103 may include, or communicate with a computing system that includes, a natural language processing service that processes the utterance to obtain the fuel code 106.

At step/operation 606, the process 600 includes temporarily storing the user input according to a storage instruction, such as a third-party storage instruction. For example, the fuel exchange system 103 may temporarily store the user input in memory 114 according to one or more storage instructions 116. In some embodiments, the process 600 includes processing the user input based on a storage instruction to determine whether the user input indicates a fuel code. For example, based on a storage instruction 116, the fuel exchange system 103 may determine whether the user input to the input device 110 includes a numeric or alphanumeric string of a predetermined format associated with fuel codes. In a particular example, based on a storage instruction 116, the fuel exchange system 103 may determine whether the user input includes a particular partition or sequence of characters that flag the user input as including or indicating a fuel code. In response to determining the user input is of the predetermined format, the fuel exchange system 103 may temporarily store the user input (e.g., or a subset thereof indicative of a fuel code 106) in memory 114, such as one or more structured query language (SQL) databases. In some embodiments, metadata is stored in addition to and in association with the user input. For example, the fuel exchange system 103 may store a timestamp in association with the user input, where the timestamp corresponds to a time at which the user input was received by the fuel exchange system 103. In another example, the fuel exchange system 103 may store a fuel volume in association with the user input, where the fuel volume corresponds to a quantity of fuel provided or allocated to a user entity during a fuel event.

At step/operation 609, the process 600 includes generating a fuel exchange authorization data object. For example, the fuel exchange system 103 may generate the fuel exchange authorization data object based on the user input such that the fuel exchange authorization data object indicates a fuel code 106. In some embodiments, the fuel exchange authorization data object includes metadata including, but not limited to, a receipt timestamp of the user input, an entity identifier corresponding to a fuel entity associated with the fuel exchange system, and/or a location of the fuel exchange system, fueling system, and/or user computing entity. In one example, the fuel exchange system 103 may determine, or receive from the user computing entity 111, geolocation data indicative of a current location of the user computing entity 111. The fuel exchange system 103 may generate a fuel exchange authorization data object including or indicative of the fuel code 106 and the geolocation data. In another example, the fuel exchange system 103 may retrieve from memory 114 an identifier 108 associated with a fuel entity that operates or owns the fuel exchange system 103. The fuel exchange system 103 may generate a fuel exchange authorization object including or indicative of the fuel code 106 and the identifier 108.

In some embodiments, generating the fuel exchange authorization data object includes a fuel exchange processing service receiving and modifying (e.g., reformatting) the fuel exchange authorization data object to include additional data. For example, the fuel exchange system 103 may generate a fuel exchange authorization data object indicative of a fuel code 106 and provide the fuel exchange authorization data object to a fuel exchange processing service 105. The fuel exchange processing service 105 may determine an identifier 108 associated with the fuel exchange system 103, such as an entity identifier of a fuel entity associated with the fuel exchange system 103. The fuel exchange processing service 156 may modify the fuel exchange authorization data object to include or indicate the identifier 108. In another example, the fuel exchange processing service 105 may determine a receipt timestamp corresponding to receipt of the fuel exchange authorization data object from the fuel exchange system 103. The fuel exchange processing service 105 may modify the fuel exchange authorization data object to include or indicate the receipt timestamp.

In some embodiments, the fuel exchange authorization data object includes a fuel volume provided to a user entity. For example, the fuel exchange authorization data object may include a number of gallons of fuel dispensed by a fueling system. In some embodiments, the fuel exchange authorization data object includes a timestamp corresponding to activation of a fueling system and/or a timestamp corresponding to completion of fueling via the fueling system. For example, the fuel exchange authorization data object may include a timestamp at which a fuel pump was activated in response to a user entity's manipulation of a fuel pump handle and/or selection of a fuel type via a graphical user interface at the fuel pump. The fuel exchange authorization data object may include a timestamp at which the fuel pump handle was reinserted into the fuel pump. In another example, the fuel exchange authorization data object includes a timestamp at which the fuel exchange system 103 provided a fueling start code to a fueling system and/or a timestamp at which the fuel exchange system 103 provided a fueling end code to the fueling system. In some embodiments, the fuel exchange authorization data object includes an identifier for the fueling system. For example, the fuel exchange authorization data object may include a fuel pump number and/or the like.

In some embodiments, the fuel exchange authorization data object includes data defining a location at which the user input was received and/or a fueling system associated with the fuel exchange is located. For example, the fuel exchange authorization data object may include a physical address of a fueling station. In some embodiments, the fuel exchange authorization data object includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange authorization data object indicates whether the fuel exchange is authorized or in-process. For example, the fuel exchange authorization data object may indicate that a fuel exchange has not been approved by a payment instrument administrator. In another example, the fuel exchange authorization data object may indicate that the fuel exchange is preauthorized and may include a preauthorization limit. In some embodiments, the fuel exchange authorization data object includes one or more product identifiers, such as a stock keeping unit (SKU), part number, product number, universal product code (UPC), standard case code (SCC) and/or the like. In one example, the fuel exchange authorization data object includes an identifier for a type of fuel provided (or requested to be provided) for the fuel exchange, a first SKU for a fuel additive product, and a third SKU for an anti-freeze product.

In some embodiments, the fuel exchange system 103 generates the fuel exchange authorization data object via existing (e.g., native or manufacturer-installed) point of sale software that outputs the fuel exchange authorization data object in a data format usable by the fuel exchange system 103 according to existing software. For example, the fuel exchange system 103 may generate the fuel exchange authorization data object in a format that corresponds to a format for fuel exchange initiated in response to receipt of traditional payment instrument data. In some embodiments, the fuel exchange system 103 stores the fuel exchange authorization data object in memory such that the fuel exchange authorization data object is accessible by other software programs. For example, the fuel exchange system 103 may store the fuel exchange authorization data object in a tabular format, a graphical database format, and/or the like, such that the fuel exchange authorization data object may be accessed by a script that recognizes the fuel exchange authorization data object and/or fuel code 106 indicated by the fuel exchange authorization data object.

In some embodiments, the script automatically retrieves the fuel exchange authorization data object and converts the fuel exchange authorization data object into a data format that may be provided to or extracted by the fuel exchange processing service 105. In some embodiments, the script reformats the fuel exchange authorization data object by concatenating one or more characters, truncating one or more characters, replacing one or more characters of, and/or adding one or more characters to, the fuel exchange authorization data object. In some embodiments, the script reformats all fuel transaction authorization data objects in an identical manner. In alternate embodiments, the script reformats each fuel transaction authorization data object in a manner unique to each fuel code. In some embodiments, the script generates a format by which to reformat the fuel exchange authorization data object based on the fuel code 106.

In some embodiments, the fuel exchange system 103 temporarily stores the fuel exchange authorization data object for a period sufficient to allow the script to reformat the fuel exchange authorization data object and provide the fuel exchange authorization data object to the fuel exchange processing service 105. In some embodiments, following the period and/or providing of the fuel exchange authorization data object to the fuel exchange processing service 105, the fuel exchange system 103 deletes the format-modified fuel exchange authorization data object from memory such that the modified data does not interfere with existing operations of the original software (e.g., native point of sale software) running on the fuel exchange system 103. In one example, temporary storage and subsequent deletion of the differently formatted fuel exchange authorization data object may prevent interference with native point of sale software that requires transaction data to be stored in an original data format. In some embodiments, the fuel exchange system 103 retains, in memory, the fuel exchange authorization data object in an unmodified format.

At step/operation 612, the process 600 includes providing the fuel exchange authorization data object to a remote computing environment. For example, the fuel exchange system 103 may provide the fuel exchange authorization data object to a remote server 200 of the remote computing environment 101 by using a fuel exchange processing service 105, one or more networks 150, and one or more application programming interfaces (APIs) 140 (e.g., configured to facilitate communication between the fuel exchange system 103 and the fuel exchange processing service 105 and/or between the fuel exchange processing service 105 and the remote server 200). In some embodiments, the fuel exchange authorization data object is relayed to the remote computing environment by the fuel exchange processing service using an API. For example, the fuel exchange processing service 105 may provide the fuel exchange authorization data object from the fuel exchange system 103 via a first network 150. The fuel exchange processing service 105 may relay the fuel exchange authorization data object to a remote server 200 of the remote computing environment 101 via a second network 150 and using an API 140.

In some embodiments, the fuel exchange system 103 executes a script (e.g., according to a storage instruction 116) that reformats the fuel exchange authorization data object from a legacy point-of sale format (e.g., or other original format used by the fuel exchange system 103) to a secondary format that enables the fuel exchange processing service 105 to recognize the fuel exchange authorization data object as including a fuel code. In some embodiments, the script further causes the fuel exchange system to temporarily store the reformatted fuel exchange authorization data object in memory and delete the reformatted fuel exchange authorization data object after the reformatted fuel exchange authorization data object is provided or collected by the fuel exchange processing service 105 (e.g., while retaining, in memory, the original formatted fuel exchange authorization data object). In some embodiments, prior to relaying the fuel exchange authorization data object to the remote computing environment, the fuel exchange processing service 105 further reformats the fuel exchange authorization data object by executing a second script, which may be defined by a second storage instruction 116 stored at and/or provided to the fuel exchange processing service 105. In some embodiments, the further reformatting of the fuel exchange authorization data object may enable the remote computing environment to recognize and process various data indicated by the fuel exchange authorization data object, such as one or more identifiers, fuel volumes, fuel exchange amounts, fuel exchange ratios, other fuel event or fuel exchange data, and/or the like.

In various embodiments, in response to receiving the fuel exchange authorization data object, the remote computing environment performs a fuel code validation process, such as the fuel code validation process 600 shown in FIG. 6 and described herein. In some embodiments, the fuel code indicated by the fuel exchange authorization data object is compared to a stored fuel code 106 (e.g., to determine whether the fuel codes match). For example, the remote server 200 queries a plurality of stored fuel codes 106 based on the indicated fuel code to determine whether a matching fuel code 106 has been generated and stored by the remote computing environment 101. Additionally, in some embodiments, the fuel exchange authorization data object includes a receipt timestamp of the user input and, to validate the indicated fuel code, the receipt timestamp is compared to a predetermined activation interval associated with the stored fuel code. Additionally, or alternatively, in some embodiments, the fuel exchange authorization data object includes an entity identifier and, to validate the indicated fuel code, the entity identifier is compared to an identifier of a fuel entity stored in association with the stored fuel code. Additionally, or alternatively, in some embodiments, geolocation data of the user computing entity associated with the stored fuel code is obtained and compared to a fueling location associated with the fuel entity to determine whether a location of the user computing entity is within a predetermined proximity of the fueling location.

At step/operation 615, the process 600 includes receiving a validation of the fuel code. In some embodiments, the validation of the fuel code is received at the fuel exchange system from the remote computing environment by way of the fuel exchange processing service and an API. For example, the remote server 200 may provide a transmission indicative of the validation of the fuel code to the fuel exchange processing service 105 using a first network 150 and an API 140. The fuel exchange processing service 105 may relay the transmission indicative of the validation of the fuel code (e.g., or generate and transmit a similar transmission) to the fuel exchange system using a second network 150. In some embodiments, additional data associated with the validated fuel code is provided from the remote computing environment to the fuel exchange system (e.g., via relaying the data using the fuel exchange processing service 105 and one or more APIs 140). For example, using the first network 150 and API 140, the remote server 200 may provide a transmission indicative of a fuel exchange ratio to the fuel exchange processing service 105, which may relay the fuel exchange ratio to the fuel exchange system 103 using a second network 150. In still another example, using the first network 150 and API 140, the remote server 200 may provide a transmission indicative of a maximum fuel volume and/or preauthorized fuel exchange amount to the fuel exchange processing service 105, which relays the maximum fuel volume and/or preauthorized fuel exchange amount to the fuel exchange system 103 using the second network 150.

Alternatively, in some embodiments, the process 600 includes receiving a rejection of the fuel code. The rejection of the fuel code may be received by the fuel exchange system 103 in similar manner to receipt of the validation of the fuel code described herein. For example, the remote server 200 may provide a transmission indicative of the rejection of the fuel code to the fuel exchange processing service 105 using a first network 150 and an API 140, and the fuel exchange processing service 105 may relay the rejection of the fuel code to the fuel exchange system 103 using a second network 150.

In one example, the remote server 200 may determine that the indicated fuel code cannot be validated based on a failure to identify a matching fuel code 106 at one or more data stores 102. In another example, the remote server 200 may determine that the indicated fuel code was received outside of a predetermined activation interval (e.g., the fuel code is expired). In another example, the remote server 200 may determine that an entity identifier received in association with the indicated fuel code fails to match an identifier 108 for a fuel entity associated with the stored fuel code 106 to which the indicated fuel code was matched. In another example, the remote server 200 may determine that geolocation data of a user computing entity 111 associated with the stored fuel code 106 is not within a predetermined proximity of a fueling location associated with the stored fuel code 106. In some embodiments, receiving the rejection of the fuel code include or indicate one or more reasons for the rejection. For example, the rejection of the fuel code may indicate that the indicated fuel code could not be matched to a stored fuel code (e.g., “code not found”). In another example, the rejection of the fuel code may indicate that the indicated fuel code was received outside of a predetermined activation (e.g., “code expired”). In another example, the rejection of the fuel code may indicate that the indicated fuel code was not provided to a fuel exchange system of an associated fuel entity (e.g., “entity not authorized”). In still another example, the rejection of the fuel code may indicate and/or that the user computing entity 111 is not located within a predetermined proximity of an associated fueling location. In some embodiments, the rejection of the fuel code may be presented to a user entity and/or provided to the user computing entity associated with the fuel code. For example, a fuel exchange system 103 may render a user interface indicative of the rejection of the fuel code on a display visible to a user entity. In another example, the remote server 200 may provide a notification indicative of the rejection of the fuel code to a user computing entity 111 associated with the fuel code.

In some embodiments, the fuel exchange system 103 updates the original fuel exchange authorization data object in response to approval or other outcome for the fuel exchange (e.g., partial approval, denial, and/or the like). In some embodiments, the above-described script performs the update by communicating with an exchange processing service that processes a payment transaction for fuel exchange (e.g., the fuel exchange processing service 105 or another external computing system). In alternate embodiments, the fuel exchange system 103 receives direct communication from the exchange processing service such that the approval of other outcome for the fuel exchange resembles a traditional transaction outcome, which may allow the fuel exchange system 103 to update the unmodified fuel exchange authorization data object in the original format. In some embodiments, following updating by the fuel exchange system 103, the script retrieves the fuel exchange authorization data object and reformats the fuel exchange authorization data object. In some embodiments, the script causes the temporary storage and subsequent deletion of the reformatted fuel exchange authorization data object in memory after the script provides the reformatted fuel exchange authorization data object to the fuel exchange processing service 105, which may relay the reformatted fuel exchange authorization data object to the remote server 200 (e.g., for recordation of the fuel exchange outcome).

At step/operation 618, the process 600 includes optionally includes transitioning a fueling system from an inactive state to an active state. For example, in response to receiving the validation of the fuel code, the fuel exchange system 103 may transition a fueling system 112 from an inactive state to an active state in which fuel may be dispensed from the fueling system 112. In another example, in response to receiving the validation of the fuel code, the fuel exchange system 103 may transition a fueling system 112 from an inactive state to an active state in which a container of fuel may be retrieved from a storage receptacle. In some embodiments, the validation of the fuel code indicates a preauthorized fuel exchange amount and/or maximum fuel volume. In some embodiments, the fueling system 112 is transitioned from the inactive state to the active state according to the preauthorized fuel exchange amount and/or maximum fuel volume such that a fuel event may be suspended in response to a user entity being provided a volume of fuel equal to the maximum fuel volume and/or having a fuel value equal to the preauthorized fuel exchange amount. In some embodiments, step/operation 618 may be performed prior to receiving the user input indicative of the fuel code. For example, a user entity may request activation of a fueling system 112 and an operator of a fuel exchange system may transition the fueling system 112 from an inactive state to an active state to allow fueling. During or following the fuel event, the user entity may present the fuel code to the operator (e.g., by displaying the fuel code as rendered on the user entity's user computing entity 111), and the operator may provide the fuel code to the fuel exchange system 103 via user input to a fuel exchange software interface or other input device or fuel exchange system interface.

In some embodiments, the fuel exchange system 103 transmits a fueling start signal to the fueling system, which causes the fueling system 112 to transition from an inactive state to an active state in which fuel may be obtained by a user entity. In some embodiments, the fuel exchange system 103 provides additional data to the fueling system 112 including a fuel type, a maximum fuel volume, and/or a maximum fuel exchange amount (e.g., which may be based on a preauthorization limit and/or the like). In some embodiments, the activation of the fueling system 112 enables the fueling system 112 to access fuel from a fuel reservoir. For example, the transition to the active state may cause opening of a valve such that fuel may be dispensed from the fueling system. In some embodiments, the activation of the fueling system 112 causes the fueling system 112 to initiate a fuel volume counter, fuel discharge rate monitor, or other device or software program that measures a volume of fuel provided by the fueling system. In some embodiments, the fueling system 112 generates a start timestamp indicative of a start time of receiving the fuel start code or dispensing of fuel from the fuel system. In some embodiments, the fueling system 112 determines that a fuel event has ended. For example, the fueling system 112 determines that a fuel pump handle has been reinserted into a fuel pump for a predetermined time period and, in response, determines that fueling has ended. In some embodiments, the fueling system 112 automatically terminates fueling (e.g., by transitioning to the inactive state) in response to determining that a particular volume of fuel has been provided to a user entity, that a value of fuel provided to the user entity meets a threshold fuel exchange amount, or that a container for receiving fuel has reached a maximum fill level. In some embodiments, the fueling system 112 terminates fueling in response to receiving a fuel end code or other signal from the fuel exchange system 103.

In some embodiments, in response to termination of fueling, the fueling system 112 generates a total fuel volume for the amount of fuel provided to the user entity and/or a fuel exchange amount based on the total fuel volume and a fuel exchange ratio. In some embodiments, the fuel exchange system 103 performs functions for monitoring a fuel event and generating data associated therewith. In some embodiments, the fueling system 112 provides to the fuel exchange system 103 data related to the fuel event including a start timestamp, end timestamp, total fuel volume, fuel exchange amount, and/or other output of a fuel counter. In some embodiments, the fuel exchange system 103 updates the original-formatted fuel exchange authorization data object based on the fuel event data. In some embodiments, following updating by the fuel exchange system 103, the script retrieves the fuel exchange authorization data object and reformats the fuel exchange authorization data object. In some embodiments, the script causes the temporary storage and subsequent deletion of the reformatted fuel exchange authorization data object in memory after the script provides the reformatted fuel exchange authorization data object to the fuel exchange processing service 105, which may relay the reformatted fuel exchange authorization data object 407 to the remote server 200 (e.g., for recordation of the fuel event data and further processing of the fuel exchange).

At step/operation 621, the process 600 includes generating a fuel exchange payload, which may be indicative of a fuel exchange amount, fuel volume, and/or additional event data. For example, the fuel exchange system 103 generates the fuel exchange payload based on a fuel event, such as the dispensing of fuel from a fuel system 112 to a user entity or a retrieval of a container of fuel by the user entity from a storage receptacle. In some embodiments, the fuel exchange amount is generated based on a fuel exchange ratio and a fuel volume. In some embodiments, the fuel exchange system 103 generates the fuel exchange payload via existing (e.g., native or manufacturer-installed) point of sale software that outputs the fuel exchange payload in a data format usable by the fuel exchange system 103 according to existing software. For example, the fuel exchange system 103 may generate the fuel exchange payload in a format that corresponds to a format for fuel exchange initiated in response to receipt of traditional payment instrument data. In some embodiments, the fuel exchange system 103 stores the fuel exchange payload in memory such that the fuel exchange payload is accessible by other software programs. For example, the fuel exchange system 103 may store the fuel exchange payload in a tabular format, a graphical database format, and/or the like, such that the fuel exchange payload may be accessed by a script that recognizes the fuel exchange payload and/or fuel code 106 indicated by the fuel exchange payload.

In some embodiments, the script automatically retrieves the fuel exchange payload and converts the fuel exchange payload into a data format that may be provided to or extracted by the fuel exchange processing service 105. In some embodiments, the script reformats the fuel exchange payload by concatenating one or more characters, truncating one or more characters, replacing one or more characters of, and/or adding one or more characters to, the fuel exchange payload. In some embodiments, the script reformats all fuel exchange payloads in an identical manner. In alternate embodiments, the script reformats each fuel exchange payload in a manner unique to each fuel code. In some embodiments, the script generates a format by which to reformat the fuel exchange payload based on the fuel code 106.

In some embodiments, the fuel exchange system 103 temporarily stores the fuel exchange payload for a period sufficient to allow the script to reformat the fuel exchange payload and provide the fuel exchange payload to the fuel exchange processing service 105. In some embodiments, following the period and/or providing of the fuel exchange payload to the fuel exchange processing service 105, the fuel exchange system 103 deletes the format-modified fuel exchange payload from memory such that the modified data does not interfere with existing operations of the original software (e.g., native point of sale software) running on the fuel exchange system 103. In one example, temporary storage and subsequent deletion of the differently formatted fuel exchange payload may prevent interference with native point of sale software that requires transaction data to be stored in an original data format. In some embodiments, the fuel exchange system 103 retains, in memory, the fuel exchange payload in an unmodified format.

In some embodiments, the fuel exchange system 103 updates the original fuel exchange payload in response to approval or other outcome for the fuel exchange (e.g., partial approval, denial, and/or the like). In some embodiments, the above-described script performs the update by communicating with an exchange processing service that processes a payment transaction for fuel exchange (e.g., the fuel exchange processing service 105 or another external computing system). In alternate embodiments, the fuel exchange system 103 receives direct communication from the exchange processing service such that the approval of other outcome for the fuel exchange resembles a traditional transaction outcome, which may allow the fuel exchange system 103 to update the unmodified fuel exchange payload in the original format. In some embodiments, following updating by the fuel exchange system 103, the script retrieves the fuel exchange payload and reformats the fuel exchange payload. In some embodiments, the script causes the temporary storage and subsequent deletion of the reformatted fuel exchange payload in memory after the script provides the reformatted fuel exchange payload to the fuel exchange processing service 105, which may relay the reformatted fuel exchange payload to the remote server 200 (e.g., for recordation of the fuel exchange outcome).

In some embodiments, in response to receiving the validation of the fuel code, a fuel exchange ratio (e.g., based upon which a fuel exchange amount is determined) is reduced from a first value, such as an advertised or consumer-directed fuel exchange ratio, to a second value. In one example, the fuel exchange system 103 may determine a fuel volume associated with a fuel event that was initiated in response to the validation of the indicated fuel code. The fuel exchange system 103 may generate a fuel exchange amount by multiplying the fuel volume by a fuel exchange ratio, where the fuel exchange ratio is different (e.g., less than) a fuel exchange ratio advertised at the corresponding fueling location. In other embodiments, the discounted fuel exchange amount is generated by the remote server 200.

In some embodiments, in addition to the fuel exchange amount, the fuel exchange payload includes metadata associated with the fuel event, the fueling location, and/or the associated fuel entity. For example, the fuel exchange payload may include a fuel event initiation and/or termination timestamp. In another example, the fuel exchange payload may include a type of fuel provide to a user entity. In another example, the fuel exchange payload may include an identifier for a fuel entity associated with the fuel exchange system 103.

In one example, the fuel exchange payload may include a number of gallons of fuel dispensed by the fueling system during the fuel event. The fuel exchange payload may also include a timestamp at which a fuel pump was activated in response to a user entity's manipulation of a fuel pump handle and/or selection of a fuel type via a graphical user interface at the fuel pump. The fuel exchange payload may include a timestamp at which the fuel pump handle was reinserted into the fuel pump. In another example, the fuel exchange payload includes a timestamp at which the fuel exchange system 103 provided a fueling start code to a fueling system and/or a timestamp at which the fuel exchange system 103 provided a fueling end code to the fueling system. In some embodiments, the fuel exchange payload includes an identifier for the fueling system. For example, the fuel exchange payload may include a fuel pump number and/or the like.

In some embodiments, the fuel exchange payload includes data defining a location at which the user input was received and/or a fueling system associated with the fuel exchange is located. For example, the fuel exchange payload may include a physical address of a fueling station. In some embodiments, the fuel exchange payload includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange payload indicates whether the fuel exchange is authorized or in-process. For example, the fuel exchange payload may indicate that a fuel exchange has not been approved by a payment instrument administrator. In another example, the fuel exchange payload may indicate that the fuel exchange is preauthorized and may include a preauthorization limit. In some embodiments, the fuel exchange payload includes one or more product identifiers, such as a stock keeping unit (SKU), part number, product number, universal product code (UPC), standard case code (SCC) and/or the like. In alternate embodiments, the remote computing environment stores one or more product identifiers in association with the fuel code 106 such that the remote computing environment may modify the fuel exchange payload to further indicate the one or more product identifiers (e.g., even in instances where the fuel exchange system 103 lacks software and/or hardware functionality to indicate such product information in fuel exchange payloads). Thus, in addition to the remote computing environment using the fuel exchange system to remotely initiate fueling systems on behalf of a user entity, the remote computing environment may overcome deficiencies of software and hardware of existing fuel exchange systems that may be incapable of providing product identification-enriched fuel exchange payload data to external computing systems.

At step/operation 624, the process 600 includes providing the fuel exchange payload to the remote computing environment. For example, the fuel exchange system 103 provides the fuel exchange payload to the remote server 200 using the fuel exchange processing service 105 and an API 140. The fuel exchange processing service 105 may receive the fuel exchange payload from the fuel exchange system 103 via a first network 150 and provide the fuel exchange payload to the remote server 200 via a second network 150 and using an API 140.

In some embodiments, the fuel exchange processing service 105 provides the fuel exchange payload to the remote server 200. The fuel exchange processing service 105 may provide the fuel exchange payload to the remote server 200 using a second API. The fuel exchange processing service 105 may modify the fuel exchange payload to include a service amount (e.g., a fee for processing fuel exchange-related data). In some embodiments, the fuel exchange processing service 105 executes a script that reformats the fuel exchange payload to indicate a service amount by concatenating one or more characters, truncating one or more characters, replacing one or more characters of, and/or adding one or more characters to, the fuel exchange payload. In some embodiments, the fuel exchange processing service provides modified fuel exchange payload to the fuel exchange system 103. In some embodiments, the fuel exchange system 103 temporarily stores the modified fuel exchange payload for a period sufficient to allow a script executed by the fuel exchange system 103, or a storage computing system in communication therewith, to reformat the modified fuel exchange payload into an original format. In some embodiments, following reformatting, the fuel exchange system 103 deletes the modified fuel exchange payload and stores the original-formatted fuel exchange payload in memory (e.g., or updates the original formatted fuel exchange authorization data object based thereon and stores the updated fuel exchange authorization data object). Deletion of the format-modified fuel exchange payload from memory and/or storage of the reformatted fuel exchange payload may prevent interference with existing operations of the original software (e.g., native point of sale software) running on the fuel exchange system 103. In one example, temporary storage and subsequent deletion of the differently formatted fuel exchange payload may prevent interference with native point of sale software that requires transaction data to be stored in an original data format. In some embodiments, as described in reference to the preceding indicia, the fuel exchange-related data generated and/or received by the original software of the fuel exchange system 103 is reformatted twice by different computing systems and/or scripts before being provided to the remote server 200. For example, a fuel exchange payload and/or fuel exchange authorization data object may be reformatted by a first script at the fuel exchange system 103 and/or a storage computing device. The fuel exchange payload and/or fuel exchange authorization data object may be reformatted a second time by a second script at the fuel exchange processing service 105 before being provided to the remote server 200.

At step/operation 627, the process 600 includes performing one or more appropriate actions to perform an exchange of value (e.g., close a transaction), initiate and/or end fueling, provide an outcome of a fuel exchange to one or more computing elements, initiate a payment transaction from an entity associated with the remote server to the fuel entity based on the fuel exchange, provide a notification to a user computing entity, and/or the like. In some embodiments, in response to receiving the fuel exchange payload, an exchange of value is processed using a user entity's instrument of exchange. For example, the remote server 200 may process an exchange of value based on the fuel exchange payload and using an instrument of exchange associated with the user entity, user computing entity 111, and/or user account 104 corresponding to the validated fuel code. In some embodiments, processing the exchange of value includes forwarding the fuel exchange payload and data indicative of the instrument of exchange to a provider of the instrument of exchange. For example, the instrument of exchange may be a credit card. The remote server 200 may provide an exchange approval request to a credit card processing partner, or other exchange instrument administrating or issuing entity, that includes the fuel exchange amount and credit card info, such as a card number, card expiration date, card verification value, cardholder name, billing address, and/or the like. The credit card processing partner may process the exchange of value for the credit card in an amount corresponding to the fuel exchange amount. The credit card processing partner may be a fuel exchange processing service 105 or other processor of credit card-based exchanges of value.

In some embodiments, the remote server 200 generates an updated fuel exchange payload based on the fuel exchange payload and/or data stored in association with the fuel code 106, such as product identifiers. For example, the remote server 200 generates an updated fuel exchange amount based on an undiscounted fuel exchange amount indicated in the fuel exchange payload and a discounted fuel exchange ratio generated by the remote server 200 when the fuel code 106 was generated (e.g., the discounted fuel exchange ratio being stored in association with the fuel code 106). In another example, the remote server 200 generates an updated fuel exchange amount based on an undiscounted fuel exchange ratio determined and stored at the time of generation of the fuel code 106.

In some embodiments, the remote server 200 generates the updated fuel exchange amount based on a retail price of the fuel, which may be indicated by the fuel exchange payload and/or determined and stored at the time of generation of the fuel code 106. For example, the remote server 200 may determine an undiscounted retail price (e.g., fuel exchange ratio) of the fuel to be $5.00 per unit volume of fuel. The remote server 200 may apply a predetermined discount value to the undiscounted retail price to generate a discounted fuel exchange ratio of $4.50 per unit volume of fuel. The remote server 200 may generate a fuel exchange amount based on the discounted fuel exchange ratio and a fuel volume indicated in the transaction payload.

In some embodiments, the remote server 200 generates the updated fuel exchange amount based on a wholesale price of the fuel, which may be indicated by the fuel exchange payload and/or determined and stored at the time of generation of the fuel code 106. For example, the remote server 200 may determine a wholesale price (e.g., fuel exchange ratio) of the fuel to be $2.50 per unit volume of fuel. The remote server 200 may apply a predetermined scaling value to the wholesale price to generate a scaled fuel exchange ratio of $3.00 per unit volume of fuel. The remote server 200 may generate a fuel exchange amount based on the scaled fuel exchange ratio and a fuel volume indicated in the transaction payload. In some embodiments, the remote server 200 further modifies the fuel exchange amount to include a service fee.

In some embodiments, the remote server 200 generates a payment amount and initiates a payment transaction to remit the payment amount to the fuel entity, where the payment amount may be a portion of the final fuel exchange amount processed in a payment transaction using the user entity's instrument of exchange. In some embodiments, the remote server 200 generates the payment amount based on a difference value between the undiscounted fuel exchange amount, the discounted fuel exchange amount by which the exchange of value for the fuel exchange was processed, and a predetermined percentage. The remote server 200 may generate the undiscounted fuel exchange amount based on a retail, wholesale, or other undiscounted fuel exchange ratio, and the fuel volume provided to the user entity. In some embodiments, the fuel exchange payload indicates the undiscounted fuel exchange amount. The remote server 200 may retrieve the predetermine percentage from the data store 102 where the predetermined percentage may be stored in association with the fuel code 106 and/or an identifier for the fuel entity. The remote server 200 may generate a difference value between the undiscounted fuel exchange amount and the discounted fuel exchange amount, such as by subtracting a discounted fuel exchange amount from a retail fuel exchange amount or by subtracting a wholesale fuel exchange amount from the discounted fuel exchange amount. The remote server 200 may generate the payment amount based on the difference value and the predetermined percentage. In some embodiments, the remote server aggregates payment amounts for a plurality of fuel exchanges associated with a fuel entity to generate an aggregate payment amount that is remitted to the fuel entity via a single payment transaction initiated by the remote server 200. For example, the remote server 200 may aggregate hourly, daily, weekly (e.g., or other suitable interval) fuel exchange amounts or payment amounts determined therefrom and process a corresponding hourly, daily, or weekly payment transaction to the fuel entity in the aggregated payment amount.

In some embodiments, to request approval of the fuel exchange amount, the remote server 200 generates and transmits a transaction processing request to a transaction processing server. In some embodiments, the transaction processing request includes the fuel exchange amount and authorization data for the user entity's instrument of exchange, such as a credit card number, expiration date, card verification value, and/or the like, and additional information from the fuel exchange payload and/or fuel exchange authorization data object described herein. In some embodiments, the remote server 200 provides the fuel exchange payload to the transaction processing server using the fuel exchange processing service 105 and/or one or more APIs. In some embodiments, the remote server 200 receives an outcome of the fuel exchange from the transaction processing server via a network 150 and using one or more APIs. The transaction processing entity may communicate with a financial institution, such as a bank, or other administrator of a user entity's instrument of exchange to obtain authorization for and process an exchange of value for the fuel exchange amount.

In some embodiments, the remote server 200 generates and provides to the fuel exchange processing service 105 and/or user computing entity 111 a fuel exchange outcome. The remote server 200 may provide the fuel exchange outcome to the fuel exchange processing service 105 using the second API. The fuel exchange outcome may indicate whether the exchange of value in the fuel exchange amount was approved, partially approved, or denied. In some embodiments, if partially approved or denied, the fuel exchange outcome may indicate one or more reasons, such as insufficient funds, preauthorization limit, suspected fraud, and/or the like.

In some embodiments, the fuel exchange processing service 105 provides the fuel exchange outcome to the fuel exchange system 103 (see indicium 12). The fuel exchange processing service 105 may provide the fuel exchange outcome to the fuel exchange system 103 using the first API. In some embodiments, the fuel exchange processing service 105 or the fuel exchange system 103 (or a storage computing system in communication therewith) executes a script that reformats the fuel exchange outcome to an original format of point-of-sale software at the fuel exchange system 103, such as by splitting one or more characters, concatenating one or more characters, truncating one or more characters, replacing one or more characters of, and/or adding one or more characters to, the fuel exchange outcome 413.

In some embodiments, the fuel exchange processing service 105 provides the fuel exchange outcome to the fuel exchange system 103. In some embodiments, the fuel exchange system 103 temporarily stores the fuel exchange outcome for a period sufficient to allow a script executed by the fuel exchange system 103, or a storage computing system in communication therewith, to reformat the modified fuel exchange outcome into an original format. In some embodiments, following reformatting, the fuel exchange system 103 deletes the received fuel exchange outcome and stores the original-formatted fuel exchange outcome in memory (e.g., or updates the original formatted fuel exchange authorization data object or fuel exchange payload based thereon and stores the updated fuel exchange authorization data object). Deletion of the received fuel exchange outcome from memory and/or storage of the reformatted fuel exchange outcome may prevent interference with existing operations of the original software (e.g., native point of sale software) running on the fuel exchange system 103. In one example, temporary storage and subsequent deletion of the differently formatted fuel exchange outcome may prevent interference with native point of sale software that requires transaction outcomes to be stored in an original data format. In some embodiments, as described in reference to the preceding indicia, the fuel exchange outcome received by the remote server 200 is reformatted twice by different computing systems and/or scripts before being stored at the fuel exchange system 103. For example, a fuel exchange outcome may be reformatted by a first script at the remote server 200. The fuel exchange outcome may be reformatted a second time by a second script at the fuel exchange processing service 105 before being provided to the fuel exchange system 103. Such reformatting processes throughout the data flow 400 may enable backwards compatibility of the present systems and methods with existing fuel exchange systems that demonstrate highly variant software and hardware configurations.

In some embodiments, the fuel exchange outcome causes the fuel exchange system 103 to activate a fueling system, such as in instances where the fuel exchange payload 411 is generated and processed prior to a fuel event. For example, the remote server 200 remotely activates a fueling system by transmitting the fuel exchange outcome to the fuel exchange system 103 using the fuel exchange processing service 105 and one or more APIs 140, effectively using the fuel exchange system 103 as a tool or interface for remotely initiating fuel events on behalf of a user entity and in a manner such that the user entity may recognize a reduced cost of obtaining fuel.

In some embodiments, the user computing entity receives a notification indicative of the outcome of the fuel exchange. For example, the remote server 200 may provide a notification to the user computing entity 111 via a network 150. The notification may indicate the outcome of the fuel exchange and additional data, such as a fuel savings amount generated by the remote server 200 based on the fuel exchange ratio and/or fuel amount and an advertised fuel exchange ratio utilized by the fuel entity for exchanges of value that are not performed based on a fuel code.

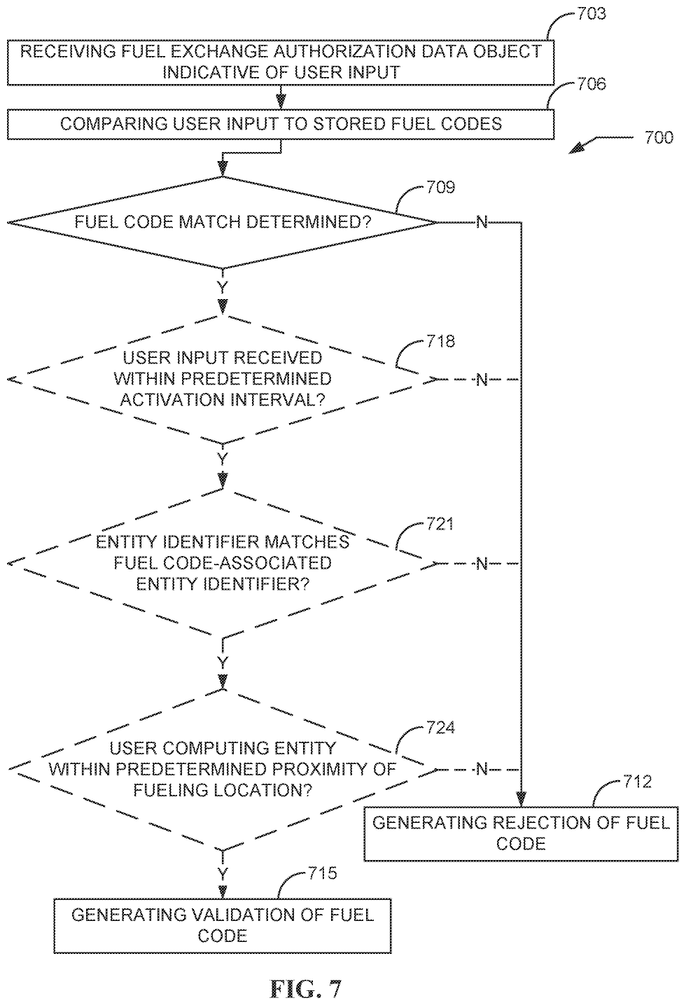

FIG. 7 provides an example flowchart of an example process 700 for validating a fuel code according to certain embodiments. In some embodiments, the process 700 is performed in response to receipt of a fuel exchange authorization data object at the remote computing environment. For example, the remote server 200 performs the process 700 in response to receiving a fuel exchange authorization data object.

At step/operation 703, the process 700 includes receiving a fuel exchange authorization data object indicative of a user input, where the user input is indicative of a fuel code. For example, the remote server 200 receives a fuel exchange authorization data object from a fuel exchange processing service 105 via a network 150 and one or more APIs 140. The fuel exchange authorization data object may be originally generated at a fuel exchange system 103 in response to the fuel exchange system 103 receiving a user input indicative of a fuel code 106. In some embodiments, the fuel exchange system 103 generates the fuel exchange authorization data object in an original format (e.g., via a native software) and executes a script to reformat the fuel exchange authorization data object into a modified format by which the fuel exchange processing service 105 may access and obtain the reformatted fuel exchange authorization data object from temporary storage (e.g., after which the reformatted fuel exchange authorization data object may be deleted and the original formatted fuel exchange authorization data object retained). In some embodiments, prior to providing the fuel exchange authorization data object to the remote server 200, the fuel exchange processing service 105 further reformats the fuel exchange authorization data object using a second script such that the further reformatted fuel exchange authorization data object may be recognized and processed by the remote server 200.

In some embodiments, in addition to indicating the user input indicative of the fuel code, the fuel exchange authorization data object includes or indicates additional data by which the fuel code may be validated and/or other aspects of a fuel exchange determined and recorded by the remote server 200. Non-limiting examples of such data include a fuel volume provided to a user entity, a timestamp corresponding to activation of a fueling system, a timestamp corresponding to completion of fueling via the fueling system, an identifier for the fueling system, data defining a location at which the user input 405 was received and/or a fueling system associated with the fuel exchange is located, an undiscounted fuel exchange amount, an undiscounted fuel exchange ratio (e.g., wholesale price, retail price, and/or the like), an indication of whether the fuel exchange is authorized or in-process, a preauthorization limit, one or more product identifiers for a fuel type and potentially other vehicle-related products (e.g., a stock keeping unit (SKU), part number, product number, universal product code (UPC), standard case code (SCC)), and/or the like.

At step/operation 706, the process 700 includes comparing the user input to one or more stored fuel codes. In some embodiments, the remote server 200 queries one or more data stores 102 to compare the received fuel code 106 to one or more stored fuel codes 106. In some embodiments, the remote server 200 queries or retrieves one or more stored fuel codes for comparison based on additional data from the fuel exchange authorization data object (e.g., or otherwise determined by the remote server based on the fuel exchange authorization data object). For example, the remote server 200 may query a particular set of stored fuel codes or retrieve one or more fuel codes for comparison based on a fuel entity identifier. In another example the remote server 200 may query a particular set of stored fuel codes or retrieve one or more fuel codes for comparison based on a fuel exchange system identifier. In another example, the remote server 200 may query a particular set of stored fuel codes or retrieve one or more fuel codes for comparison based on a fueling location identifier. In another example, the remote server 200 may query a particular set of stored fuel codes or retrieve one or more fuel codes for comparison based on a current or historical location of one or more user computing entities 111 and a fueling location identifier. In another example, the remote server 200 may query a particular set of stored fuel codes or retrieve one or more fuel codes for comparison based on one or more product identifiers, such as an identifier for a particular fuel type, fuel additive, or vehicle fluid. The remote server 200 may query a particular set of stored fuel codes or retrieve one or more fuel codes for comparison based on multiple identifiers and/or other data.

At step/operation 709, the process 700 includes determining whether the fuel code indicated by the fuel exchange authorization data object matches a stored fuel code. For example, the remote server 200 may include determining that the stored fuel code to which the user input-indicated fuel code was matched has not been previously used in a fuel exchange. The stored fuel code may be associated with a utilization indicator and the remote server 200 may determine whether the utilization indicator indicates previous usage of the stored fuel code. In some embodiments, in response to determining user input matches stored fuel code, process 700 may proceed to step/operation 715 or, optionally, one or more of steps/operations 718-724. In some embodiments, in response to determining user input does not matched stored fuel code, or that a matched fuel code has previously been used, process 700 may proceed to step/operation 712.

At step/operation 712, the process 700 includes generating a rejection of the fuel code, which may be provided to a fuel exchange system via a fuel exchange processing service and an application programming interface (API). For example, the remote server 200 may generate the rejection of the fuel code, which may include a rejection of the fuel exchange authorization data object. The remote server 200 may provide the rejection of the fuel code to the fuel exchange processing service 105 using a network 150 and one or more APIs 140. The fuel exchange processing service 105 may relay the rejection of the fuel code to the fuel exchange system 103 using a second network 150 and one or more APIs 140. In some embodiments, prior to relaying the rejection of the fuel code, the fuel exchange processing service 105 executes a script that reformats the rejection of the fuel code from a first format to a second format recognizable to the fuel exchange system 103 (e.g., an original format utilized by existing point-of-sale software). For example, the script splits one or more characters, concatenates one or more characters, truncates one or more characters, replaces one or more characters of, and/or adds one or more characters to, the rejection of the fuel code.

At step/operation 715, the process 700 includes generating a validation of the fuel code, which may be provided to a fuel exchange system 103 via a fuel exchange processing service 105 using a network 150 and one or more APIs 140. In one example, the remote server 200 may generate the validation of the fuel code in a first format and the fuel exchange processing service 105 may execute a script to reformat the validation of the fuel code to an original format utilized by original software of the fuel exchange system 103, thereby preserving backwards compatibility with legacy infrastructure and processes. In some embodiments, the remote server 200 retrieves a fuel exchange ratio, maximum fuel volume, and/or preauthorization limit stored in association with the fuel code. The validation of the fuel code may indicate or include the fuel exchange ratio, maximum fuel volume, and/or preauthorization limit.

At step/operation 718, the process 700 optionally includes determining whether the user input indicative of the fuel code was received with a predetermined activation interval. In some embodiments, the remote server 200 retrieves an activation interval associated with stored fuel code and/or a creation or request timestamp of the stored fuel code. In some embodiments, the remote server 200 compares a receipt timestamp of the user input to the activation interval and/or to the creation timestamp. In some embodiments, in response to the remote server 200 determining the user input was received within the activation interval of the fuel code, the process 700 proceeds to step/operation 715, or, optionally, step/operations 721 and/or 724. In some embodiments, in response to determining the user input was received outside of the activation interval, the process 700 proceeds to step 712.

At step/operation 721, the process 700 optionally includes determining whether an entity identifier indicated by the fuel exchange authorization data object matches an identifier of a fuel entity associated with the matched fuel code. In some embodiments, the remote server 200 compare the entity identifier from the fuel exchange authorization data object to identifier of a fuel entity stored in association with the matched fuel code. In some embodiments, in response to the remote server 200 determining the entity identifier matches the stored fuel entity identifier, the process 700 proceeds to step/operation 715, or optionally steps/operations 718 and/or 724. In some embodiments, in response to the remote server 200 determining the entity identifier does not match the stored fuel entity identifier, the process 700 proceeds to step/operation 712.

At step/operation 724, the process 700 optionally includes determining whether a user computing entity 111 associated with the user input is within a predetermined proximity of a fueling location associated with the fuel entity. In some embodiments, the remote server 200 requests and receives geolocation data associated with user computing entity 111. In some embodiments, the remote server 200 determines a current location of user computing entity 111 based on the geolocation data. In some embodiments, the remote server 200 determines, or receives from a data store 102, a fueling location associated with the stored fuel code and/or associated fuel entity identifier. In some embodiments, the remote server 200 compares the current location of the user computing entity 111 to the fueling location to generate a proximity of the current location to the fueling location. In some embodiments, the remote server 200 determines whether the generated proximity is within a predetermined proximity threshold, which may be a physical distance or travel time (e.g., 200 miles, 100 miles, 50 miles, 12 hours, 6 hours, 30 minutes, or any suitable distance or travel time). In some embodiments, in response to the remote server 200 determining that the location of the user computing entity 111 is within the predetermined proximity to the fueling location, the process 700 proceeds to step/operation 715, or, optionally, steps/operations 718 and/or 724. In some embodiments, in response to the remote server 200 determining that the location of the user computing entity 111 is outside of the predetermined proximity to the fueling location, the process 700 proceeds to step/operation 712.

### Example User Interfaces

FIG. 8 provides an example fuel exchange software interface 800 for receiving a user input indicative of a fuel code according to certain embodiments. In various embodiments, the fuel exchange software interface 800 is generated and rendered on a display of a fuel exchange system based on original software executed by the fuel exchange system. In some embodiments, the fuel exchange software interface 800 includes a user input field 803 configured to receive user input. In some embodiments, the fuel exchange software interface 800 includes a selectable field 806 that, when selected via user input, causes the fuel exchange system to process a user input to the user input field 803 as a traditional payment instrument identifier, such as a credit card number, debit card number, banking account number, and/or the like. For example, the user input field 803 may be rendered or enabled based on selection of the selectable field 806 and may be a legacy or existing user input field traditionally utilized for manually inputting a payment card number. In some embodiments, a script installed at and executed by the fuel exchange system enables the system to receive, at the user input field 803, a user input indicative of a fuel code such that the fuel code is received and processed in a format that will be accepted, at least temporarily, by the locally executable software on the fuel exchange system. The fuel code may be stored in memory that is accessible by external software systems so that the complete transaction data can be intercepted before it is transmitted as a traditional fuel exchange transaction (e.g., which would result in the denial/rejection of the transaction/fuel code as an improper payment method) and can be redirected to the system components discussed herein for processing a transaction using the fuel code. In some embodiments, selection of the selectable field 806 cause the fuel exchange system, or a storage computing system in communication therewith, to execute the script.

FIG. 9 provides an example graphical user interface (GUI) 900 for providing a fuel code to a fuel exchange system according to certain embodiments. In some embodiments, the GUI 900 is rendered on a display of the user computing entity 111 by the application 122. In some embodiments, the GUI 900 includes a fuel code 106, which may be presented to an operator of a fuel exchange system such that the operator may provide the fuel code 106 to the fuel exchange system via user input. In some embodiments, the GUI 900 includes an entity identifier 903 that includes a name of a fuel entity, an address of a fueling location, and/or a selectable link that, when selected, causes the user computing entity 111 to initiate a navigation application for navigating to the address of the fueling location. In some embodiments, the GUI 900 includes an undiscounted fuel exchange ratio associated with the fuel entity or fueling location, such as an undiscounted retail price currently advertised or otherwise utilized by the associated fuel exchange system. In some embodiments, the GUI 900 includes a discounted fuel exchange ratio 907. In some embodiments, the application 122 may receive the discounted fuel exchange ratio 907 from the remote computing environment in combination with or following receipt of the fuel code. In some embodiments, the application 122 receives one or more discounted fuel exchange ratios and renders a map interface on which locations of one or more fueling locations and corresponding discounted fuel exchange ratios are indicated. In some embodiments, the application 122 receives the discounted fuel exchange ratio 907 from the remote computing environment in response to requesting generation of a fuel code for the corresponding fueling location.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for fuel exchange authorization and optimization, comprising:
receiving, at a fuel exchange system, a user input indicative of a fuel code via a fuel exchange software interface, wherein the fuel code is generated by a remote computing environment which stores the fuel code in association with an identifier of a fuel entity associated with the fuel exchange system and which provides the fuel code to a user computing entity;
temporarily storing, in a memory of the fuel exchange system, the user input according to a third-party storage instruction executable by the fuel exchange system;
providing, using a fuel exchange processing service and an application programming interface (API), a fuel exchange authorization data object indicative of the user input to the remote computing environment;
receiving, at the fuel exchange system, a validation of the fuel code, wherein:
the remote computing environment generates the validation of the fuel code based on a comparison of the user input to the fuel code; and
the validation of the fuel code is received from the remote computing environment via the fuel exchange processing service and the API;
in response to receiving the validation of the fuel code, generating a fuel exchange payload indicative of a fuel exchange amount, the identifier of the fuel entity associated with the fuel exchange system, and the fuel code; and
providing, using the fuel exchange processing service and the API, the fuel exchange payload to the remote computing environment.

2. The computer-implemented method of claim 1, further comprising:
in response to receiving the validation of the fuel code, transitioning a fueling system from an inactive state to an active state, wherein the fuel exchange amount is based on a fuel event associated with the fueling system in the active state.

3. The computer-implemented method of claim 1, wherein:
the fuel exchange authorization data object comprises metadata indicative of a receipt timestamp of the user input; and
the remote computing environment generates the validation of the fuel code further based on determining the receipt timestamp is within a predetermined activation interval.

4. The computer-implemented method of claim 3, wherein:
the fuel exchange authorization data object comprises an entity identifier; and
the remote computing environment generates the validation of the fuel code further based on a comparison between the entity identifier and the identifier of the fuel entity associated with the fuel code at the remote computing environment.

5. The computer-implemented method of claim 1, wherein:
the remote computing environment generates the validation of the fuel code further based on determining the user computing entity is within a predetermined proximity to a fueling location associated with the fuel entity.

6. The computer-implemented method of claim 1, further comprising:
receiving, at the fuel exchange system, a fuel exchange ratio from the remote computing environment via the fuel exchange processing service and the API; and
generating the fuel exchange amount at least partially based upon the fuel exchange ratio.

7. The computer-implemented method of claim 6, wherein:
the remote computing environment stores the fuel exchange ratio in association with the fuel code and the identifier of the fuel entity.

8. The computer-implemented method of claim 1, further comprising:
installing the third-party storage instruction at the fuel exchange system prior to receiving the user input.

9. The computer-implemented method of claim 8, wherein the third-party storage instruction, when installed at the fuel exchange system, causes the fuel exchange system to:
determine the user input comprises a predetermined format defined by the third-party storage instruction; and
in response to determining the user input comprises the predetermined format, provide, using the fuel exchange processing service and the API, the fuel exchange authorization data object indicative of the user input to the remote computing environment.

10. The computer-implemented method of claim 1, further comprising:
determining, using the remote computing environment, a user account based on the fuel code; and
updating, using the remote computing environment, the user account based on the fuel exchange amount and the identifier of the fuel entity associated with the fuel exchange system.

11. The computer-implemented method of claim 1, wherein the fuel exchange software interface comprises a computing device in communication with the fuel exchange system.

12. A system for fuel exchange authorization and optimization, the system comprising at least one memory and one or more processors in communication with the at least one memory, wherein the one or more processors are configured to:
receive, at a fuel exchange system, a user input indicative of a fuel code via a fuel exchange software interface, wherein the fuel code is generated by a remote computing environment which stores the fuel code in association with an identifier of a fuel entity associated with the fuel exchange system and which provides the fuel code to a user computing entity;
temporarily store, in the at least one memory, the user input according to a third-party storage instruction executable by the fuel exchange system;
provide, using a fuel exchange processing service and an application programming interface (API), a fuel exchange authorization data object indicative of the user input to the remote computing environment;
receive, at the fuel exchange system, a validation of the fuel code, wherein:
the remote computing environment generates the validation of the fuel code based on a comparison of the user input to the fuel code; and
the validation of the fuel code is received from the remote computing environment via the fuel exchange processing service and the API;
in response to receiving the validation of the fuel code, generate a fuel exchange payload indicative of a fuel exchange amount, the identifier of the fuel entity associated with the fuel exchange system, and the fuel code; and
provide, using the fuel exchange processing service and the API, the fuel exchange payload to the remote computing environment.

13. The system of claim 12, wherein the one or more processors are further configured to:
in response to receiving the validation of the fuel code, transition a fueling system from an inactive state to an active state, wherein the fuel exchange amount is based on a fuel event associated with the fueling system in the active state.

14. The system of claim 12, wherein:
the fuel exchange authorization data object comprises metadata indicative of a receipt timestamp of the user input; and
the remote computing environment generates the validation of the fuel code further based on determining the receipt timestamp is within a predetermined activation interval.

15. The system of claim 14, wherein:
the fuel exchange authorization data object comprises an entity identifier; and
the remote computing environment generates the validation of the fuel code further based on a comparison between the entity identifier and the identifier of the fuel entity associated with the fuel code at the remote computing environment.

16. The system of claim 12, wherein:
the remote computing environment generates the validation of the fuel code further based on determining the user computing entity is within a predetermined proximity to the a fueling location associated with the fuel entity.

17. The system of claim 12, wherein the one or more processors are further configured to:
receive, at the fuel exchange system, a fuel exchange ratio from the remote computing environment via the fuel exchange processing service and the API;
generate the fuel exchange amount at least partially based upon the fuel exchange ratio.

18. The system of claim 17, wherein:
the remote computing environment stores the fuel exchange ratio in association with the fuel code and the identifier of the fuel entity.

19. The system of claim 12, wherein the one or more processors are further configured to:
install the third-party storage instruction at the fuel exchange system prior to receiving the user input.

20. A computer program product comprising a non-transitory computer readable medium having computer program instructions stored therein, the computer program instructions, when executed by a processor, cause the processor to:
receive, at a fuel exchange system, a user input indicative of a fuel code via a fuel exchange software interface, wherein the fuel code is generated by a remote computing environment which stores the fuel code in association with an identifier of a fuel entity associated with the fuel exchange system and which provides the fuel code to a user computing entity;
temporarily store, in the at least one memory, the user input according to a third-party storage instruction executable by the fuel exchange system;
provide, using a fuel exchange processing service and an application programming interface (API), a fuel exchange authorization data object indicative of the user input to the remote computing environment;
receive, at the fuel exchange system, a validation of the fuel code, wherein:
the remote computing environment generates the validation of the fuel code based on a comparison of the user input to the fuel code; and
the validation of the fuel code is received from the remote computing environment via the fuel exchange processing service and the API;
in response to receiving the validation of the fuel code, generate a fuel exchange payload indicative of a fuel exchange amount, the identifier of the fuel entity associated with the fuel exchange system, and the fuel code; and
provide, using the fuel exchange processing service and the API, the fuel exchange payload to the remote computing environment.
